(19) United States
(12) Patent Application Publication
(10) Pub. No.: US 2012/0201475 A1
(43) Pub. Date: Aug. 9, 2012

(54) METHOD AND SYSTEM FOR PROCESSING AN IMAGE

(75) Inventors: Sharon Carmel, Ramat Hasharon (IL); Dror Gill, Haifa (IL); Tamar Shoham, Netanya (IL)

(73) Assignee: I.C.V.T. LTD., Tel-Aviv (IL)

(21) Appl. No.: 13/500,457

(22) PCT Filed: Oct. 5, 2010
(86) PCT No.: PCT/IL10/00811

§ 371 Date: Apr. 5, 2012

Related U.S. Application Data
(60) Provisional application No. 61/248,521, filed on Oct. 5, 2009.
(60) Provisional application No. 61/253,872, filed on Oct. 22, 2009.
(60) Provisional application No. 61/302,193, filed on Feb. 8, 2010.

(51) Int. Cl. G06K 9/36

(52) U.S. Cl. 382/238

(57) ABSTRACT

There is provided according to an aspect the present invention a method and a system for processing a discrete input image to a reduced-size discrete output image. According to some embodiments, the system may include an interface, a quality parameter controller and an intra-prediction encoder. The quality controller is adapted to provide an encoding-quality parameter enabling a substantial size reduction of the discrete output image, wherein the parameter is related to a target quantitative-similarity measure between the output image and the input image. The intra-prediction encoder is adapted to re-encode the input image, wherein re-encoding includes intra-image prediction, and wherein the encoder is configured in accordance with the encoding-quality parameter.

### CROSS REFERENCE TO RELATED APPLICATIONS

This application claims priority from and incorporates herein by reference the entire disclosure of U.S. Provisional Application No. 61/248,521, filed on Oct. 5, 2009, and of U.S. Provisional Application No. 61/253,872, filed on Oct. 22, 2009, and of U.S. Provisional Application No. 61/302,193, filed on Feb. 8, 2010.

### FIELD OF THE INVENTION

The present invention is in the field of image processing. More particularly, the present invention is in the field of lossy image processing.

### LIST OF REFERENCES

The following references are considered to be pertinent for the purpose of understanding the background of the present invention:
[1] S. Cho, Z. Bojkovic, D. Milovanovic, J. Lee, and J. Hwang, “Image quality evaluation: JPEG2000 versus Intra-only H.264/AVC High Profile”, FACTA UNIVERSITATIS Elec. Energ., vol. 20, no. 1, 71-83 (April 2007)
[2] F. De Simone, M. Ouaret, F. Dufaux, A. G. Tescher, and T. Ebrahimi, “A comparative study of JPEG 2000, AVC/H.264, and HD Photo”, Applications of Digital Image Processing XXX, Proceedings of SPIE, vol. 6696, San Diego, Calif. USA, 28-30, Aug. 2007.
[3] Ismail Dalgic, Fouad A. Tobagi, “Constant Quality Video Encoding”, Proc. of IEEE ICC '95, Seattle, Wash., June 1995.
[4] I. Matsuda, Y. Nomoto, K. Wakabayashi and S. Itoh, “Lossless Re-encoding of JPEG Images Using Block-Adaptive Intra. Prediction” Proc. of 16th European Signal Processing Conference (EUSIPCO 2008), Lausanne, Switzerland, L3-6, Aug. 25-29, 2008.
[5] Anthony J Maeder, Birgit M Planitz, “Medical Image Watermarking for Multiple Modalities,” aipr, pp. 158-165, 34th Applied Imagery and Pattern Recognition Workshop (AIPR '05), 2005.
[6] Z. Wang, A. C. Bovik, H. R. Sheikh, E. P. Simonelli, “Image Quality Assessment: From Error Visibility to Structural Similarity”, IEEE Transactions on Image Processing, Vol. 13, No. 4, pp. 600-612, April 2004.
[7] M. Martinez-Rach, O. Lopez, P. Pinol, M. P. Malumbres and J. Oliver, “A Study of Objective Quality Assessment Metrics for Video Codec Design and Evaluation”, IEEE International Symposium on Multimedia, pp. 517-524, December 2006 (ISM '06)

### BACKGROUND OF THE INVENTION

Cho et al. [1] discloses image quality evaluation for intra-only H.264/AVC High Profile (HP) standard versus JPEG2000 standard. In particular, The structure of the two standards and the coding algorithms in the context of subjective and objective assessments are provided. Also disclosed are simulations that were performed on a test set of monochrome and color image. Cho et al., determine based on observations that the subjective and objective image quality of H.264/AVC is superior to JPEG2000, except the blocking artifact which is inherent, since it consists of block transform rather than whole image transform.

Simone et al. [2] report a study evaluating rate-distortion performance between JPEG 2000, AVC/H.264 High 4:4:4 Intra and HD Photo. For evaluation, a set of ten high definition color images with different spatial resolutions has been used. Both the PSNR and the perceptual MSSIM index were considered as distortion metrics. According to Simone et al., results show that, for the material used to carry out the experiments, the overall performance, in terms of compression efficiency, are quite comparable for the three coding approaches, within an average range of ±10% in bitrate variations, and outperforming the conventional JPEG.

Matsuda et al. [3] propose a transcoding scheme which compresses existing JPEG files without any loss of quality. In this scheme, H.264-like block-adaptive intra prediction is employed to exploit inter-block correlations of quantized DCT coefficients stored in the JPEG file. This prediction is performed in spatial domain of each block composed of 8×8 pixels, but the corresponding prediction residuals are calculated in DCT domain to ensure lossless reconstruction of the original coefficients. Moreover, block-based classification is carried out to allow accurate modeling of probability density functions (PDFs) of the prediction residuals. A multisymbol arithmetic coder along with the PDF model is used for entropy coding of the prediction residual of each DCT coefficient.

Dalgic and Tobagi [4] propose a video encoding scheme which maintains the quality of the encoded video at a constant level. This scheme is based on a quantitative video quality measure, and it uses a feedback control mechanism to control the parameters of the encoder.

### SUMMARY OF THE INVENTION

There is provided according to an aspect the present invention a method and a system for processing a discrete input image to a reduced-size discrete output image. According to some embodiments, the system may include an interface, a quality parameter controller and an intra-prediction encoder. The quality controller is adapted to provide an encoding-quality parameter enabling a substantial size reduction of the discrete output image, wherein the parameter is related to a target quantitative-similarity measure between the output image and the input image. The intra-prediction encoder is adapted to re-encode the input image, wherein re-encoding includes intra-image prediction, and wherein the encoder is configured in accordance with the encoding-quality parameter.

According to some embodiments, the target quantitative-similarity measure represents an acceptable difference between the output image and the input image. In further embodiments, the target quantitative-similarity measure represents a minimal similarity requirement between the output image and the input image.

In some embodiments, the encoding-quality parameter is set by a fixed and predefined value. In further embodiments, the encoding-quality parameter is computed according to a predefined formula. In still further embodiments, the encoding-quality parameter is selected from a pre-generated look-up table. In yet a further embodiment, the encoding-quality parameter is determined by a predefined iterative search process that is based on predefined search criteria.

In some embodiments, the target quantitative-similarity measure is denoted by a minimum similarity value representing a minimum threshold for similarity between the output image and the input image. In further embodiments, the target quantitative-similarity measure is denoted by a maximum difference value representing a maximum threshold for difference between the output image and the input image. In still further embodiments, the target quantitative-similarity measure is also denoted by a minimum difference value or by a maximum similarity value giving rise to a difference or similarity range, respectively.

In some embodiments, the minimum similarity value and/or the maximum difference value denote a perceptually identical quantitative-similarity (or quantitative-difference). In further embodiments, the minimum similarity value (or the maximum difference value) is denoted by a specific structural similarity (SSIM) index value and specific values of associated parameters. In still further embodiments, the minimum similarity value (or the maximum difference value) corresponds or is substantially equivalent to a structural similarity (SSIM) index value of approximately 0.95 with the following parameters: an 11×11 Gaussian filter with sigma=1.5, and default values for the SSIM constants—[0.01, 0.03]. In yet further embodiments of the invention, the quality parameter controller is adapted to provide an encoding-quality parameter which provides an SSIM index value that equals or is greater than 0.95 with the following parameters or some equivalent thereof, and which enables a substantial size reduction relative to the input image.

In still further embodiments, the minimum similarity value (or the maximum difference value) is determined using a modified SSIM quality measure. The SSIM quality measure is adapted by applying to certain areas of the image a penalty, giving rise to the modified SSIM quality measure. The SSIM score computed for those areas is penalized according to the respective penalty. In one example, the penalty may involve, for example, squaring the obtained SSIM value in smooth areas. Further by way of example, smooth areas are identified by calculating the local image variance in the original image and classifying areas for which the variance is below a threshold as smooth. Other penalties may be used and may be applied in a different manner to the SSIM value for the respective areas. The regional penalty procedure may be integrated with the SSIM scoring process or may be implemented as an additional step which is implemented after the SSIM scoring process is complete. Furthermore other types of areas may exist and the identification thereof may involve further techniques in addition to local image variance.

In yet further embodiments, the SSIM quality measure is modified, so that instead of averaging over all local SSIM scores, averaging is done over the areas with lowest SSIM as determined by a predefined threshold. In further embodiments, the image is divided into blocks, the SSIM quality measure is calculated for each block separately, and then a global quality score is calculated based on the block scores, and the minimum similarity value used by the system corresponds to the block-wise global quality score.

In further embodiments, the calculation of the SSIM quality measure may be optimized by performing it on a selected portion of the pixels of the input image and the corresponding pixels of output image, instead of performing it on the whole image.

In further embodiments, the minimum similarity value (or the maximum difference value) is denoted by a specific peak signal to noise ratio (PSNR) index value and specific values of associated parameters. In still further embodiments of the invention, the quality parameter controller is adapted to provide an encoding-quality parameter which is equivalent to a peak signal-to-noise ratio value of approximately 45 dB.

In further embodiments, the minimum similarity value (or the maximum difference value) is denoted by a quality measure comprising a blockiness measure quantifying absence of blockiness of the output image relative to the input image; a textural measure quantifying textural similarities between the output image and the input image; and a local similarity measure quantifying local similarities between the output image and the input image. Further details of such quality measure are described in the co-pending U.S. Provisional Application No. 61/292,622, filed 6 Jan. 2010 entitled “Recompression of Digital Images Using a Robust Measure of Perceptual Quality Including Improved Quantization Matrix Computation” which is incorporated in to the present application as “Appendix A”.

In further embodiments of the invention, the minimum similarity value (or the maximum difference value) is denoted by a specific visual information fidelity (VIF) value and specific values of associated parameters. In further embodiments of the invention, the minimum similarity value (or the maximum difference value) is denoted by a specific picture quality scale (PQS) index value and specific values of associated parameters. In further embodiments of the invention, the minimum similarity value (or the maximum difference value) is denoted by a specific video quality metric (VQM) index value and specific values of associated parameters. In further embodiments of the invention, the minimum similarity value (or the maximum difference value) is denoted by a specific perceptual evaluation of visual quality (PEVQ) index value and specific values of associated parameters. In further embodiments of the invention, the minimum similarity value (or the maximum difference value) is denoted by a specific Moscow State University (MSU) blockiness index value and specific values of associated parameters. In further embodiments of the invention, the minimum similarity value (or the maximum difference value) is denoted by a specific Moscow State University (MSU) bluriness index value and specific values of associated parameters.

In some embodiments, the quality parameter controller is adapted to obtain an input image quality parameter related to a quantitative measure of the input image. The quality parameter controller may use the input image quality parameter for characterizing the quality of the input image. In some embodiments, the input image quality parameter may include one or more of the following: bits per pixel, image quality indication, resolution, file size, and/or minimal non-zero DCT coefficients. According to some embodiments, for higher quality input images substantially lower values of encoding-quality parameters may be provided to obtain perceptually lossless compression. In further embodiments the input image quality parameter may be used as part of a search for an encoding-quality parameter. In still further embodiments, input image quality parameter may be used to initialize the iterative encoding-quality parameter search process. In yet further embodiments, input image quality parameter may be used to determine whether the encoding process should be performed at all.

In further embodiments, the quality controller may be adapted to identify input images that are already highly compressed, and refrain from re-compressing them. In some embodiments, the input image is analyzed to identify whether it is highly compressed, and in case it is highly compressed, the encoding process is disabled for the respective image. In further embodiments, identifying whether the input image is highly compressed is performed by analyzing the DCT coefficient values of the input image after dequantization, and determining the minimum non-zero DCT coefficient value. In yet further embodiments, the minimum non-zero DCT coefficient is compared to a threshold. In some embodiment, the threshold is determined by evaluating all (or some) recompressed images for which the recompression rate is low (for example, below 10%) and examining the statistics of their non-zero DCT values. For example, a threshold of 3 for Luma may be used as described below. In some embodiments, such analysis is performed separately on the Luma and Chroma components of the image. In further embodiments, if the minimum non-zero DCT coefficient is higher than a threshold, the encoding process is not performed for the respective image. In yet further embodiments, the threshold is different for the Luma component and the Chroma components, and the final decision depends on a combination of the Luma and Chroma component thresholds. As mentioned above, here too, the threshold may be determined empirically by evaluating the statistics of DCT values in images whose recompression ratio is very low. In some embodiments, the threshold for the Luma component minimal non-zero DCT component is 3.

In some embodiments of the invention, the quality controller is adapted to provide an encoding-quality parameter which maximizes a size reduction of the discrete output image (compared to the input image) while maintaining similarity between the output image and the input image according to the target quantitative-similarity measure. In further embodiments, the quality controller is adapted to provide an encoding-quality parameter which maximizes a size reduction of the discrete output image (compared to the input image) while maintaining a similarity between the output image and the input image above or equal to the minimum similarity value. In still further embodiments, the quality controller is adapted to provide an encoding-quality parameter which maximizes a size reduction of the discrete output image (compared to the input image) while maintaining a difference between the output image and the input image above or equal to the maximum difference value.

In further embodiments, the quality controller is adapted to provide an encoding-quality parameter which enables a substantial size reduction of the discrete output image while maintaining similarity (or difference) between the output image and the input image within the predefined similarity (or difference) range.

According to some embodiments, the quality controller may include a similarity evaluation module. The similarity evaluation module may be adapted to implement in cooperation with the intra-prediction encoder an iterative search for an encoding-quality parameter, wherein at each iteration of the search, the encoding-quality parameter is incremented (or decremented) until a convergence criterion is met. According to further embodiments, the convergence criterion is associated with an improvement in terms of a size reduction associated with the current encoding-quality parameter compared to the size reduction associated with one or more of the previous encoding-quality parameters. In further embodiments, the convergence criterion is associated with a rate of improvement in terms of a size reduction associated with the current encoding-quality parameter compared to the size reduction associated with one or more of the previous encoding-quality parameters. In still further embodiments, the search for an encoding-quality parameter is constrained by a minimum similarity threshold between the output image and the input image (or by a maximum difference threshold).

According to a further embodiment, the similarity evaluation module may be configured to implement an iterative encoding-quality parameter search in cooperation with the intra-prediction encoder, where at each iteration, at least a segment of the input image is compressed using a provisional encoding-quality parameter that is provided for the current iteration, followed by an evaluation of the similarity between a resulting provisional compressed output image and the input image. In some embodiments, in case it is determined that the similarity between the provisional compressed output image and the input image meets the criteria, the quality controller may indicate to the encoder to provide as output the current provisional output image. In some embodiments, in case it is determined that the similarity between the provisional compressed output image and the input image does not meet the similarity criteria, the similarity evaluation module may be adapted to repeat the recompression of the input image using an adjusted provisional encoding-quality parameter followed by an evaluation of the similarity between a resulting provisional compressed output image and the input image. The process of adjusting the provisional encoding-quality parameter and evaluating the recompression of the input image using the adjusted provisional parameter may be repeated until the similarity between the provisional compressed output image and the input image meets the similarity criteria. In still further embodiments, the search criteria may also be related to the size reduction enabled by the provisional encoding-quality parameter.

In some embodiments, the provisional encoding-quality parameter is updated by performing a bi-section on a limited range of encoding-quality parameters. In further embodiments, the encoding-quality parameter range is updated by performing a bi-section on values of encoding-quality parameters which are specified in a look-up table.

In some embodiments, the provisional encoding-quality parameter is updated using an adaptive step size which depends on the iteration number and the distance from the target similarity measure: One such update scheme could be for example:

QPnew=QPold+sign(Δsimilarity)*min(step_{numIter},C₁*|Δsimilarity|); (Formula f1)

Where: QPnew, QPold are the values of the encoding-quality parameter for the next iteration and last iteration respectively, Δsimilarity is as in Formula f2, step_{numIter} is a step size taken from a look-up-table and decreases as a function of the iteration count and C₁ is some constant, possibly 200, and

where: Δsimilarity=currSimilarity−ThresholdSimilarity (Formula f2)

Where: currSimilarity is the similarity evaluated with the image created in the last iteration, ThresholdSimilarity is the target similarity measure and Δsimilarity is the difference between them.

According to some embodiments, the system may further include a resolution control module that is adapted to control the resolution of the output image based at least in part on the resolution of the input image. In further embodiments, the resolution control module may be adapted to obtain a parameter related to the resolution of the input image. The resolution of the input image may be denoted by a first number of pixels over a second number of pixels. In further embodiments of the invention, the resolution control module may be adapted to configure the encoder to provide as output an image having a resolution which is substantially equal to the resolution of the input image.

In some embodiments of the invention, the encoder is adapted to pad the output image with or subtract from the output image one or a substantially small number of pixel rows and/or columns. The encoder may add the relatively small number of pixels to achieve parity between the pixel dimensions of the output image and the input image. In further embodiments, the intra-prediction encoder may determine whether padding of (subtracting from) the output image is required and the number of padding rows and/or columns (or rows and/or columns to be subtracted) according to the input image resolution parameter. In still further embodiments of the invention, in case the input image has an uneven number of pixel rows and/or an uneven number of pixel columns, the intra-image prediction encoder may be adapted to pad the output image or to subtract from the output image an uneven number of pixels rows and/or columns thereby rendering even the number of pixel rows and the number of pixel columns in the output image.

In further embodiments, the intra-prediction encoder may be configured to set the resolution of the output image to a number which is significantly different from the resolution of the input image. In still further embodiments, the intra-prediction encoder may be configured to set the resolution of the output image based in part upon the resolution of the input image, and further based upon additional parameters independent of the resolution of the input image. In still further embodiments, the intra-prediction encoder may be configured to set the resolution of the output image independently of the resolution of the input image.

According to further embodiments, the intra-prediction encoder may be configured to split the output image into a plurality (two or more) of sub-images, wherein the resolution of each one of said sub-images is smaller or equal to the maximum resolution supported by the H.264 standard. In still further embodiments, the sub-images may created by splitting the output image into rectangular regions. The order of the regions associated with each of the sub-images may be denoted by a predefined order of the sub-image, or it may be specified within or associated with the sub-images. For example, a meta-tag may be embedded by the encoder in each of the sub-images indicating the respective sub-image's coordinate or column-row location. In still further embodiments, the sub-images may be stored as separate frames in a single H.264 stream, as separate H.264 tracks in a single MP4 file, or as separate H.264 files. The sub-images may be reconstructed by the decoder to recreate the original output image. In some embodiments, combining the plurality of sub-images may involve ordering the sub-images according to ordering information embedded within or associated with each of the sub-images or according to a predefined ordering scheme.

In still further embodiments, the sub-images may be created by downsampling the output image, for example dividing the output image into N images by selecting every Nth pixel in the output image. The downsampled sub-images may be stored as separate frames in a single H.264 stream, as separate H.264 tracks in a single MP4 file, or as separate H.264 files. The location of pixels in the downsampled in the original output image may be determined according to a predefined downsampling scheme, or it may be specified within or associated with the sub-images. For example, a meta-tag may be embedded by the encoder in each of the sub-images indicating the respective sub-image's pixel-wise offset relative to the edges of the original output image. In order to reconstruct the original output image, the decoder reads the pixels of the downsampled images, and writes them to a reconstructed output image—having the same size as the original output image—at the location from where they (the pixels) were located in the original output image.

According to some embodiments, the encoder is adapted to implement a quantization operation as part of the re-encoding of the input image. In further embodiments, the quantization operation is configured in accordance with the encoding-quality parameter. In still further embodiments, the encoder is adapted to configure the quantization operation in accordance with the encoding-quality parameter. In still further embodiments, the encoding-quality parameter is the quantization parameter that is used as part of the quantization operation. In yet further embodiments, the quantization parameter is approximately between 15-25. In still further embodiments, the quantization parameter is approximately between 14-32. The quantization operation may be carried out by a dedicated quantization module which is implemented as part of the encoder.

According to some embodiments of the invention, re-encoding of the input image includes computing a residual representation based on the intra-image prediction. The computation of the residual image may be carried out by a dedicated residual computation module which is implemented as part of the encoder.

In further embodiments, re-encoding of the input image further includes transforming blocks from the residual representation to a frequency domain representation. The transformation of the blocks from the residual representation to a frequency domain representation may be carried out by a dedicated transformation module which is implemented as part of the encoder. In still further embodiments, the transformation module is an integer transformation module and the transformation is an integer transformation.

In still further embodiments, re-encoding of the input image further includes quantizing the frequency domain representation matrix in accordance with the encoding quality parameter.

In yet further embodiments, re-encoding of the input image further includes reordering and coding the quantized frequency domain representation matrix using variable length coding or arithmetic coding. The reordering and coding of the quantized frequency domain representation matrix may be carried out by a dedicated entropy coding module which is implemented as part of the encoder.

According to further embodiments, re-encoding of the input image further includes converting the input image color space from RGB to YCbCr. According to yet further embodiments, re-encoding of the input image further includes reducing the spatial resolution of the Cb and Cr components. The conversion of input image color space and the reduction of the spatial resolution of certain color components of the converted input image may be carried out by a dedicated format conversion module which is implemented as part of the encoder. In further embodiments, dedicated format conversion module may be implemented outside the decoder and may implement preprocess the input to the encoder.

In some embodiments, the input image is a standard JPEG image. In still further embodiments, the input image is a standard JPEG image which is a compressed version of the raw data captured by a respective imaging device. In still further embodiments, the input image is a high quality JPEG image. According to yet further embodiments of the invention, the resolution of the input image is larger than 2 Mega-pixels.

In further embodiments, the encoder is a standard H.264 or a standard MPEG-4 part 10 encoder. In yet further embodiments, the encoder is configured to disable inter-frame (or inter-image) prediction and to implement a quantization operation in accordance with the encoding quality parameter. In still further embodiments, the standard H.264 or MPEG-4 part 10 encoder is configured to disable an in-loop deblocking filter. In some embodiments, the encoder may be adapted to enable the in-loop deblocking filter. In still further embodiments, the encoder may determine whether to enable or disable the in-loop deblocking filter according to a parameter related to the quality of the input image. In still further embodiments, the encoder may determine whether to enable or disable the in-loop deblocking filter according to an encoding-quality parameter provided by the quality parameter controller. For example, the encoder may be configured to enable the in-loop deblocking filter for an input image characterized by relatively low quality.

According to some embodiments, the encoder is adapted to provide as output a standard H.264 or MPEG-4 part 10 stream which comprises the discrete output image. In still further embodiments, the encoder is adapted to provide as output a standard H.264 or MPEG-4 part 10 stream which comprises a plurality of discrete images. In yet further embodiments, the encoder is adapted to provide as output a standard MP4 file formatted according to the MPEG-4 file format.

According to further embodiments, the system may include a bitstream packing module. The bitstream packing module may be adapted to pack the coded frequency domain representation provided by the intra-prediction encoder to a predefined output format. The bitstream packing module is adapted to provide as output a discrete output image that is coded to the predefined format. In further embodiments, the bitstream packing module may be adapted to pack the coded frequency domain representation provided by the inter-prediction encoder to the original format of the input image. In further embodiments, the bitstream packing module is adapted to provide as output a standard JPEG file which comprises a discrete image corresponding to the input image.

According to a further aspect of the invention, a system for processing a discrete input image to a reduced-size discrete output image may include an interface, a quality parameter controller and an encoder, wherein the interface is adapted to receive a discrete input image compressed by a compression format utilizing wavelets with lossless or lossy quantization and block-by-block bit-plane entropy coding. The quality controller is adapted to provide an encoding-quality parameter enabling a substantial size reduction of the discrete output image, wherein the parameter is related to a target quantitative-similarity measure between the output image and the input image. The intra-prediction encoder is adapted to re-encode the input image, wherein re-encoding includes intra-image prediction, and wherein the encoder is configured in accordance with the encoding-quality parameter.

In accordance with further embodiments of the invention, the input image is a standard JPEG 2000.

According to yet a further aspect of the invention, a system for processing a discrete input image to a reduced-size discrete output image may include an interface, a quality parameter controller and an encoder, wherein the interface is adapted to receive a discrete input image compressed by a compression format utilizing frequency domain transformation on one or more segments of the input image. The quality controller is adapted to provide an encoding-quality parameter enabling a substantial size reduction of the discrete output image, wherein the parameter is related to a target quantitative-similarity measure between the output image and the input image. The encoder is adapted to re-encode the input image using intra-image prediction implemented in accordance with the encoding-quality parameter.

According to still a further aspect of the invention, there is provided a method of processing a discrete input image to a reduced-size discrete output image, comprising: receiving a discrete input image compressed by a compression format utilizing independent coding of disjoint blocks; providing an encoding-quality parameter enabling a substantial size reduction of the discrete output image, wherein the parameter is related to a target quantitative-similarity measure between the output image and the input image; and re-encoding the input image, wherein re-encoding includes intra-image prediction, and a quantization step that is configured in accordance with the encoding-quality parameter.

According to still a further aspect of the invention, there is provided a method of processing a discrete input image to a reduced-size discrete output image, comprising: receiving a discrete input image a discrete input image compressed by a compression format utilizing wavelets with lossless or lossy quantization and block-by-block bit-plane entropy coding; providing an encoding-quality parameter enabling a substantial size reduction of the discrete output image, wherein the parameter is related to a target quantitative-similarity measure between the output image and the input image; and re-encoding the input image, wherein re-encoding includes intra-image prediction, and a quantization step that is configured in accordance with the encoding-quality parameter.

According to another aspect of the invention, there is provided a method of processing a discrete input image to a reduced-size discrete output image, comprising: receiving a discrete input image compressed by a compression format utilizing intra-prediction encoding; providing an encoding-quality parameter enabling a substantial size reduction of the discrete output image, wherein the encoding-quality parameter is related to a target quantitative-similarity measure between the output image and the input image; and re-encoding the input image, wherein re-encoding includes intra-image prediction, and a quantization step that is configured in accordance with the encoding-quality parameter.

According to yet a further embodiment of the invention, there is provided a system for processing a plurality of input images to provide a respective plurality of reduced-size output images, comprising: an interface adapted to receive a plurality of discrete input images compressed by a compression format utilizing independent coding of disjoint blocks or compressed by a compression format utilizing wavelets with lossless or lossy quantization and block-by-block bit-plane entropy coding; a quality parameter controller adapted to provide for each one of the plurality of input images an encoding-quality parameter enabling a substantial size reduction of the respective discrete output image, wherein the parameter is related to a target quantitative-similarity measure between the respective output image and input image pair; and an intra-prediction encoding controller adapted to re-encode each one of the plurality of input images, wherein re-encoding includes intra-image prediction, and wherein the encoder is configured in accordance with the respective encoding-quality parameter provided for each one of the plurality of input images.

According to some embodiments, the system may further include a plurality of quality parameters control instances under the control of said quality parameter controller, and wherein each one of the plurality of quality parameters control instances is assigned with one or more of the plurality of input images and is adapted to provide for each one of the input images assigned thereto an encoding-quality parameter enabling a substantial size reduction of the respective discrete output image, wherein the parameter is related to a target quantitative-similarity measure between the respective output image and input image pair.

According to some embodiments, the system may further include a plurality of instances of an intra-prediction encoder and wherein each one of the plurality of instances of the intra-prediction encoder is assigned with one or more of the plurality of input images to re-encode each one of the input images assigned thereto, wherein re-encoding includes intra-image prediction, and wherein the encoder is configured in accordance with the respective encoding-quality parameter provided for each one of the input images assigned to the encoder instance.

In accordance with a further aspect of the invention, there is provided a system for processing a plurality of input images, including: an interface adapted to receive a plurality of discrete input images compressed by a compression format utilizing independent coding of disjoint blocks or compressed by a compression format utilizing wavelets with lossless or lossy quantization and block-by-block bit-plane entropy coding; a quality controller adapted to provide for each one of the plurality of input images an encoding-quality parameter enabling a substantial size reduction of the respective discrete output image, wherein the parameter is related to a target quantitative-similarity measure between the respective output image and input image pair; an intra-prediction encoder adapted to re-encode each one of the plurality of input images, wherein re-encoding includes intra-image prediction, and wherein the encoder is configured in accordance with the respective encoding-quality parameter provided for each one of the plurality of input images; and a bitstreams packing module adapted to provide a single output file for the plurality of input images, the output file including a plurality of indexed discrete objects corresponding to the plurality of discrete input images.

According to some embodiments, each one of the objects includes a discrete image which corresponds to a respective one of the plurality of discrete input images. According to further embodiments, the output file is an MP4 file.

According to a further aspect of the invention there is provided, a method of processing a plurality of input images to provide a respective plurality of reduced-size output images, comprising: receiving a plurality of discrete input images compressed by a compression format utilizing independent coding of disjoint blocks or compressed by a compression format utilizing wavelets with lossless or lossy quantization and block-by-block bit-plane entropy coding; providing for each one of the plurality of input images an encoding-quality parameter enabling a substantial size reduction of the respective discrete output image, wherein the parameter is related to a target quantitative-similarity measure between the respective output image and input image pair; and re-encoding each one of the plurality of input images, wherein re-encoding includes intra-image prediction, and wherein a quantization step is configured in accordance with the respective encoding-quality parameter provided for each one of the plurality of input images. In some embodiments, at least some of the images from amongst the plurality of input images are processed in series. In still further embodiments the initial encoding-quality parameter for one of the plurality of input images is set according to the values of the encoding-quality parameters of the previous image in the series. In still further embodiments, the initial encoding-quality parameter for the input images is set according to the encoding-quality parameter to which the encoding-quality parameter values for the previous image in the series converged to.

According to a further aspect of the invention, there is provided a method of processing a plurality of input images, comprising: receiving a plurality of discrete input images compressed by a compression format utilizing independent coding of disjoint blocks or compressed by a compression format utilizing wavelets with lossless or lossy quantization and block-by-block bit-plane entropy coding or compressed by a compression format utilizing intra-prediction encoding; providing for each one of the plurality of input images an encoding-quality parameter enabling a substantial size reduction of the respective discrete output image, wherein the parameter is related to a target quantitative-similarity measure between the respective output image and input image pair; re-encoding each one of the plurality of input images, wherein re-encoding includes intra-image prediction, and wherein a quantization step is configured in accordance with the respective encoding-quality parameter provided for each one of the plurality of input images; and providing a single output file for the plurality of input images, the output file including a plurality of indexed discrete objects corresponding to the plurality of discrete input images.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a high level block diagram illustration of a image processing system according to some embodiments of the invention;

FIG. 2 is a flowchart illustration of a method of processing a discrete input image according to some embodiments of the present invention;

FIG. 3 is a flowchart illustration of an example of an iterative encoding-quality parameter search process which may be implemented as part of some embodiments of the present invention;

FIG. 4 is a block diagram illustration showing the system of FIG. 1 in further detail, according to some embodiments of the invention;

FIG. 5 is a series of images depicting certain aspects of the H.264 standard intra-image prediction and residual image computation process which are implemented as part of a process of re-encoding a discrete input image, according to some embodiments of the invention;

FIG. 6, is a block diagram illustration of an image processing system suitable for processing JPEG 2000 images, according to some embodiments of the invention;

FIG. 7 is a block diagram illustration of an image processing system suitable for processing multiple input images, according to some embodiments of the invention; and

FIG. 8 is a block diagram illustration of an image processing system suitable for processing multiple input images and for re-compressing multiple input images into a discrete output file including a plurality of discrete segments, according to some embodiments of the invention

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

Unless specifically stated otherwise, as apparent from the following discussions, it is appreciated that throughout the specification discussions utilizing terms such as “processing”, “computing”, “calculating”, “determining”, “generating”, “assigning”, “encoding”, “decoding”, “compressing” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Throughout the description of the present invention, reference is made to the term “H.264” or to the term “H.264 standard” and similar to terms which refer to “H.264” or the “H.264 standard”. It would be appreciated by those versed in the art that “H.264” or the “H.264 standard” as used herein is equivalent to MPEG-4 part 10 which is also a standard for video compression. Furthermore, the term “advanced video coding” or in abbreviation “AVC” is also a term which is interchangeable with H.264 and MPEG-4 part 10 and any reference made herein to any of the terms H.264, MPEG-4 part 10, AVC or the like is interchange with any one of the other corresponding terms.

There is provided according to an aspect of the present invention a method and a system for processing a discrete input image to a reduced-size discrete output image. According to some embodiments, the system may include an interface, a quality parameter controller and an intra-prediction encoder. The interface is adapted to receive a discrete input image compressed by a compression format utilizing independent coding of disjoint blocks. The quality controller is adapted to provide an encoding-quality parameter enabling a substantial size reduction of the discrete output image, wherein the parameter is related to a target quantitative-similarity measure between the output image and the input image. The intra-prediction encoder is adapted to re-encode the input image, wherein re-encoding includes intra-image prediction, and wherein the encoder is configured in accordance with the encoding-quality parameter.

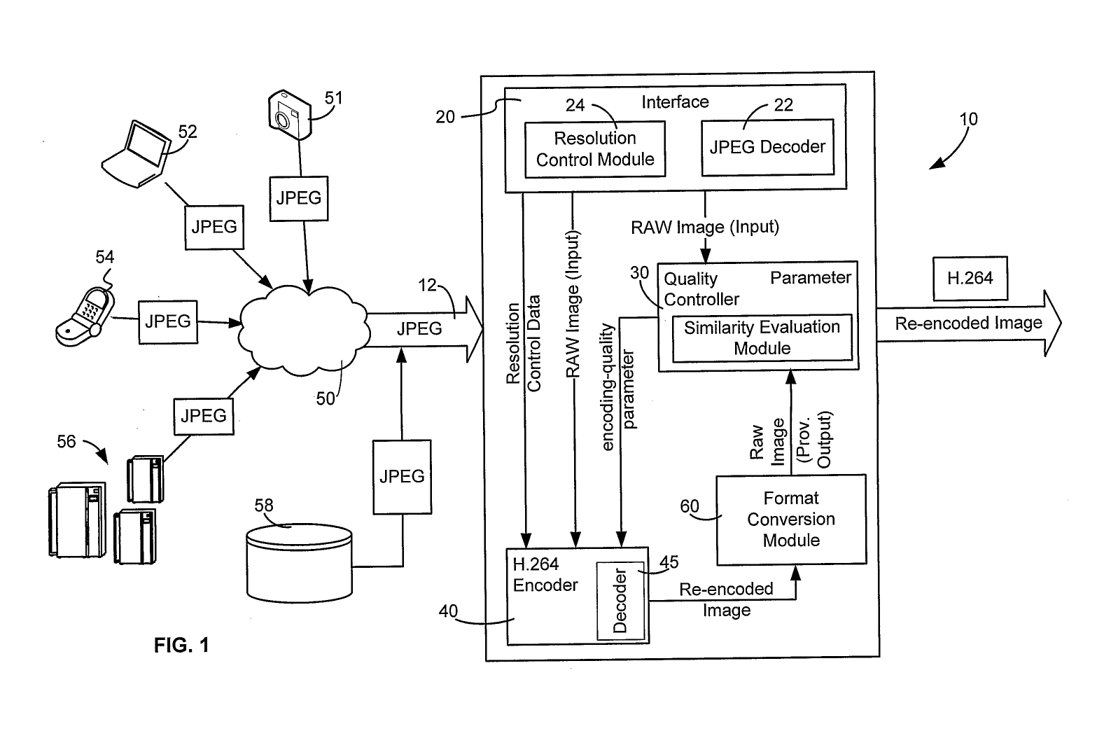

Reference is now made to FIG. 1, which is a high level block diagram illustration of a discrete input image processing system, according to some embodiments of the invention. For convenience in the embodiments shown in FIG. 1 and in the description thereof provided herein, reference is made to recompression of JPEG images. In some embodiments, the system 10 may include an input interface 20, a quality parameter controller 30 and a H.264 encoder 40.

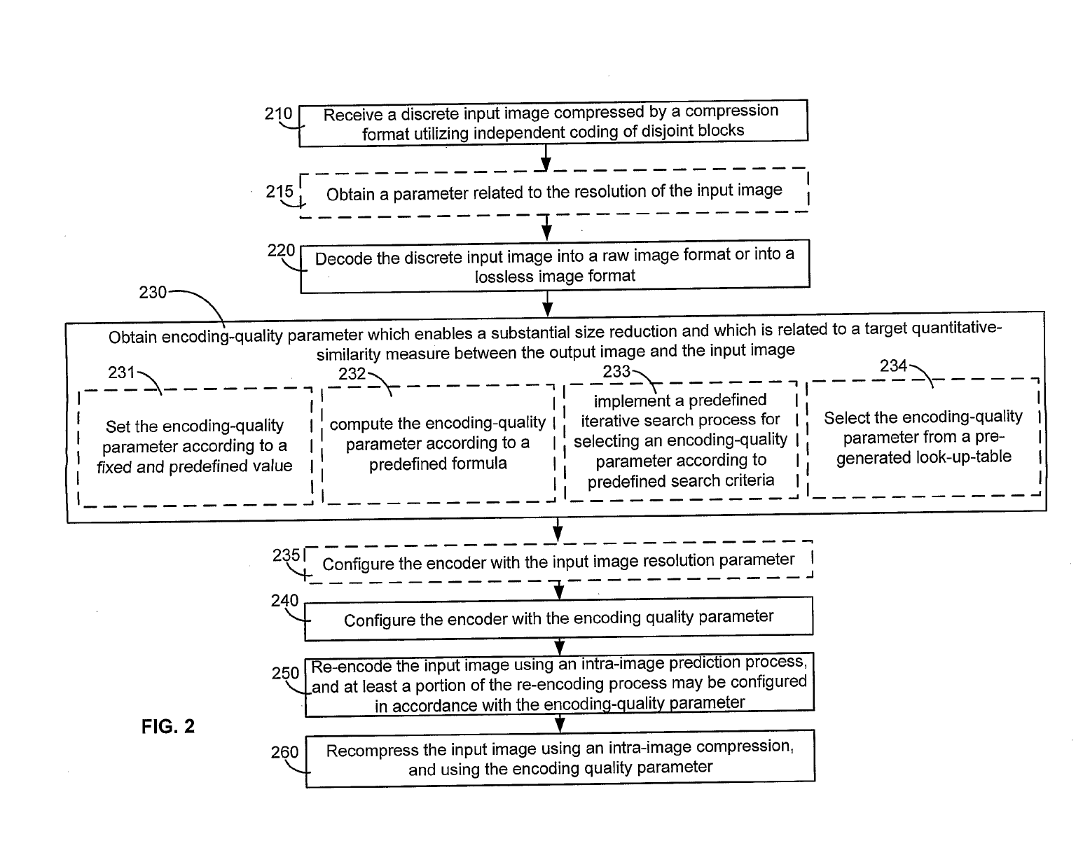

Additional reference is now made to FIG. 2, which is a flowchart illustration of a method of processing a discrete input image according to some embodiments of the present invention. The process begins with the receipt of a discrete input image compressed by a compression format utilizing independent coding of disjoint blocks. The interface 20 is adapted to receive the discrete input image compressed by a compression format utilizing independent coding of disjoint blocks (block 210), such as a discrete JPEG image 12 compressed in accordance with the JPEG standard, as is shown by way of example in FIG. 1. In some embodiments, the discrete input image is a high-quality JPEG image.

There are various possible sources for the input image, including, but not limited to, remote devices connected to the system 10 over a network 50, such as a digital camera 51, a personal computer 52, a mobile communication device 54 or a data center 56, and local devices, such as a local storage device 58 (e.g., a hard drive disk).

In some embodiments, the interface 20 may include a decoder that is adapted to decode the discrete input image into a RAW image format or into a lossless image format (block 220). For example, the decoder may decode the compressed image into any one of the following formats: YUV, RGB, BMP, PNG and TIFF. In the embodiment shown in FIG. 1, the decoder is a JPEG decoder 22 which is adapted to decode the input JPEG image into a RAW image. In further embodiments, the decoder may be configured to perform partial decoding of the input image and may translate the compressed image to a representation in the pixel domain. In still further embodiments, the decoder may be configured to perform partial decoding of the input image and may translate the compressed image to a representation in the frequency domain. In yet further embodiments, the decoder is a JPEG decoder 22 as mentioned above, and the JPEG decoder 22 is configured to perform partial decoding of the input JPEG image. In yet further embodiments, the JPEG decoder 22 may directly extract the YUV 4:2:0 samples created as part of the JPEG decoding process.

The quality parameter controller 30 may be operatively connected to the interface 20. The raw image may be fed as input to the quality parameter controller 30. As mentioned above, the quality parameter controller 30 is adapted to provide an encoding-quality parameter enabling a substantial size reduction of the discrete output image, wherein the parameter is related to a target quantitative-similarity measure between the output image and the input image (block 230). According to some embodiments, the target quantitative-similarity measure represents an acceptable difference between an output image of the system and the input image. In further embodiments, the target quantitative-similarity measure represents a minimal similarity requirement between the output image and the input image.

In some embodiments, the quality parameter controller 30 may be configured to set the encoding-quality parameter according to a fixed and predefined value (block 231). In further embodiments, the quality parameter controller 30 may be configured to compute the encoding-quality parameter according to a predefined formula (block 232). In still further embodiments, the quality parameter controller 30 may implement a predefined iterative search process for selecting an encoding-quality parameter according to predefined search criteria (block 233). In yet further embodiments the quality parameter controller 30 is adapted to select the encoding-quality parameter from a pre-generated look-up-table (block 234). More details with respect to each of the above options shall be provided below.

In FIG. 1 and according to some embodiments of the present invention, by way of example, a preconfigured H.264 encoder 40 is used as the intra-prediction encoder. In accordance with some embodiments, the H.264 encoder 40 may be preconfigured in a manner to enable intra-image prediction and to disable inter-image (or inter-frame) prediction.

In further embodiments, the H.264 encoder 40 may be preconfigured in a manner to disable an in-loop deblocking filter. In some embodiments, the H.264 encoder 40 may be preconfigured in a manner to enable the in-loop deblocking filter. In still further embodiments, H.264 encoder 40 may be configured to determine whether to enable or disable the in-loop deblocking filter according to a parameter related to the quality of the input image. In still further embodiments, the encoder may determine whether to enable or disable the in-loop deblocking filter according to encoding-quality parameter provided by the quality parameter controller. For example, the H.264 encoder 40 may be configured to enable the in-loop deblocking filter for an input image characterized by relatively low quality. It would be appreciated that, while in some cases, using a H.264 deblocking may improve perceived quality of an output image re-encoded the H.264 encoder 40, the deblocking effect may reduce the perceived similarity between the output and the input images.

Resuming the description of FIG. 2, The H.264 encoder 40 may be operatively connected to the quality parameter controller 30, and the encoding-quality parameter may be fed to the H.264 encoder 40. The H.264 encoder 40 may be configured with the encoding-quality parameter (block 240). The H.264 encoder 40 may be also operatively connected to the interface 20 and may receive as further input the representation of the input image as generated by a decoder such as the JPEG decoder 22. The H.264 40 may be adapted to re-encode the input image using an intra-image prediction process, and at least a portion of the re-encoding process may be configured in accordance with the encoding-quality parameter (block 250). Further details with respect to the re-encoding process shall be provided below.

There is now provided a description of further embodiments of the invention which are related to the encoding-quality parameter and to the operation of the quality parameter controller 30. In some embodiments, the target quantitative-similarity measure is denoted by a minimum similarity value representing a minimum threshold for similarity between the output image and the input image. In further embodiments, the target quantitative-similarity measure is denoted by a maximum difference value representing a maximum threshold for difference between the output image and the input image. The quality parameter controller 30 may select, compute or otherwise determine the encoding-quality parameter in accordance with such minimum similarity value or in accordance with such maximum difference value. In still further embodiments, the target quantitative-similarity measure is also denoted by a difference or a difference range, including maximum and minimum similarity or difference values.

In some embodiments, the minimum similarity value and/or the maximum difference value that are used by the quality parameter controller 30 may denote a required level of quantitative-similarity (or quantitative-difference). In further embodiments, the level of quantitative-similarity required by the quality parameter controller 30 corresponds to a perceptual identity. As described herein, the proposed encoding process is sensitive to the encoding-quality parameter. Thus, for example, in some embodiments, the quality parameter controller 30 may require that the encoding-quality parameter is set such that a measure of similarity between the re-encoded output image and the input image is equal to or exceeds a minimum target quantitative-similarity measure, for example, a minimum target quantitative-similarity measure representing perceptual identity (or perceived as lossless). In a similar manner and according to further embodiments, the quality parameter controller 30 may require that the encoding-quality parameter is set such that a measure of difference between the re-encoded output image and the input image is less than a maximum quantitative-difference measure.

In some embodiments, the minimum similarity value or the maximum difference value may be hard-coded into quality parameter controller 30. In further embodiments, the minimum similarity value or the maximum difference value may be manually set by an operator of the system 10.

In further embodiments, the minimum similarity value (or the maximum difference value) is denoted by a specific structural similarity (SSIM) index value and specific values of associated parameters. In still further embodiments, the minimum similarity value (or the maximum difference value) corresponds or is substantially equivalent to a structural similarity (SSIM) index value of approximately 0.95 with parameters including: an 11×11 Gaussian filter with sigma=1.5, and default values for the SSIM constants—[0.01, 0.03]. It has been acknowledged that an SSIM value equal or greater than 0.95 with the above parameters represents images which are perceptually identical (see for example publication [5]). Thus, according to some embodiments, an output and input image pair which are associated with a quantitative measure of similarity is equal to or above an SSIM value of 0.95, measured when the parameters are a 11×11 Gaussian filter with sigma=1.5, are considered to be perceptually lossless. It would be appreciated that using a different set of parameters, different SSIM values may be provided which correspond to a perceptual lossless output and input image pair, and that further embodiments of the invention are applicable to any such combination of equivalent SSIM value and associated parameters.

It would be appreciated by those versed in the art that SSIM can be used detect changes in structural information, and is therefore highly sensitive to changes along edges in the image, but is less sensitive than the Human Visual System to mild distortions in smooth areas. Therefore, in further embodiments, the minimum similarity value (or the maximum difference value) is determined using a modified SSIM quality measure. The SSIM quality measure is adapted by applying to certain areas of the image a penalty, giving rise to the modified SSIM quality measure. The SSIM score computed for those areas is penalized according to the respective penalty. In one example, the penalty may involve squaring the obtained SSIM value in smooth areas. Further by way of example, smooth areas are identified by calculating the local image variance in the original image and classifying areas for which the variance is below a threshold as smooth. Still further by way of example, the threshold for images with a dynamic range of [0,255] may be 10. In still further embodiments, the threshold is calculated per image. Other penalties may be used and may be applied in a different manner to the SSIM value for the respective areas. The regional penalty procedure may be integrated with the SSIM scoring process or may be implemented as an additional step which is implemented after the SSIM scoring process is complete.

Furthermore, the quality parameter controller 30 may be configured to identify other types of areas and the identification of such areas may involve further techniques in addition to local image variance. Once identified the SSIM scoring for such additional types of area may be subject to various modifications. The modification can be implemented as part of the SSIM scoring process and as a complimentary procedure before of after the SSIM scoring procedure.

In yet further embodiments, the SSIM quality measure is modified so that instead of averaging over all local SSIM scores, averaging is done over the areas with lowest SSIM, as determining by a predefined threshold, for example by discarding the 5% lowest outliers, and averaging over the next 10% lowest scores. In further embodiments, the image is divided into blocks, possibly based on the input image resolution, and the SSIM quality measure is calculated for each block separately, and then a global quality score is calculated as the minimum block SSIM value, the RMS (Root Mean Square) of the block SSIM values or the average between the lowest block SSIM value and the mean of the block SSIM values may be used. By way of example, a 32×32 block division is implemented for images less than 0.25 megapixels, a 64×64 block division is implemented for images between 0.25 megapixels and 1 megapixel, and a 128×128 block division is implemented for images larger than 1 megapixels

In further embodiments, the calculation of the SSIM quality measure is adapted by performing it on a selected portion of the pixels of the first image and the corresponding pixels of the second image, instead of performing it on the whole image. In further embodiments, the differences between corresponding selected pixels are combined into a single difference value by calculating their average. In further embodiments, the difference between corresponding selected pixels is combined to a single difference value by calculating their RMS (root mean square). In further embodiments, the location of selected pixels is distributed evenly across the image area. In still further embodiments, the location of selected pixels is selected randomly. In yet further embodiments, the image is divided into substantially equal rectangular areas, and a relative portion of pixels for measurement is randomly selected from each rectangular area.

In some embodiments of the invention, the minimum similarity value (or the maximum difference value) is denoted by a specific visual information fidelity (VIF) value and specific values of associated parameters. In further embodiments of the invention, the minimum similarity value (or the maximum difference value) is denoted by a specific picture quality scale (PQS) index value and specific values of associated parameters. In further embodiments of the invention, the minimum similarity value (or the maximum difference value) is denoted by a specific video quality metric (VQM) index value and specific values of associated parameters. In further embodiments of the invention, the minimum similarity value (or the maximum difference value) is denoted by a specific perceptual evaluation of visual quality (PEVQ) index value and specific values of associated parameters. In further embodiments of the invention, the minimum similarity value (or the maximum difference value) is denoted by a specific Moscow State University (MSU) blockiness index value and specific values of associated parameters. In further embodiments of the invention, the minimum similarity value (or the maximum difference value) is denoted by a specific Moscow State University (MSU) bluriness index value and specific values of associated parameters.

In yet further embodiments of the invention, the quality parameter controller 30 is adapted to provide an encoding-quality parameter which enables configuration of the encoding process to achieve an output image whose similarity to the input image is measured by an SSIM index value that equals or is greater than 0.95 with the above mentioned parameters or some equivalent thereof, and with a substantial size reduction relative to the input image.

In further embodiments, the minimum similarity value (or the maximum difference value) is denoted by a specific peak signal to noise ratio (PSNR) index value and specific values of associated parameters. In some embodiments, the PSNR quality measure is used in conjunction with an iterative search for an encoding-quality parameter. As part of the process, at each iteration a different QP is used and the PSNR is checked against a threshold PSNR level. The QP is reduced until the resulting image crosses the PSNR threshold. In still further embodiments of the invention, the quality parameter controller is adapted to provide an encoding-quality parameter which results in a peak signal-to-noise ratio value of approximately 45 dB.

In yet further embodiments of the invention, the target quantitative-similarity measure between the output image and the input image to which the encoding-quality parameter is related is associated with a blockiness measure quantifying absence of blockiness of the output image relative to the input image; a textural measure quantifying textural similarities between the output image and the input image; and a local similarity measure quantifying local similarities between the output image and the input image. Further details with respect to the quality measure are described in the co-pending U.S. Provisional Application No. 61/292,622, filed 6 Jan. 2010 entitled “Recompression of Digital Images Using a Robust Measure of Perceptual Quality Including Improved Quantization Matrix Computation” which is incorporated in to the present application as “Appendix A”.

In some embodiments of the invention, the quality parameter controller 30 is adapted to determine and provide an encoding-quality parameter which maximizes a size reduction of the discrete output image (compared to the input image) while maintaining similarity between the output image and the input image according to the target quantitative-similarity measure. In further embodiments, the quality parameter controller 30 is adapted to provide an encoding-quality parameter which maximizes a size reduction of the discrete output image (compared to the input image) while maintaining a similarity between the output image and the input image above or equal to the minimum similarity value. In still further embodiments, the quality parameter controller 30 is adapted to provide an encoding-quality parameter which maximizes a size reduction of the discrete output image (compared to the input image) while maintaining a difference between the output image and the input image above or equal to the maximum difference value.

In further embodiments, the quality parameter controller 30 is adapted determine and to provide an encoding quality parameter which enables a substantial size reduction of the discrete output image while maintaining similarity (or difference) between the output image and the input image within a predefined similarity (or difference) range.

In still further embodiments, the quality parameter controller 30 is adapted to determine and to provide an encoding-quality parameter which optimizes a similarity (or difference) between the output image and the input image and a size reduction of the discrete output image. In further embodiments, the quality parameter controller 30 may be configured to take into account other factors in the optimization of the encoding-quality parameter, including for example a convergence criterion which sets forth a condition for termination the optimization process, for example when the difference in size of the output image at a current iteration of the optimization process is less than a certain value compared to the size of the output image at one or more previous iterations. According to another example, the optimization of the encoding-quality parameter may be constrained by a maximum number of iterations. The maximum number of iterations may be predefined or may be determined according to a convergence rate or some other parameter related to the optimization process. In some embodiments the encoding-quality parameter optimization process may be implemented with respect to a certain range of similarity (or difference) between the output image and the input image, and the encoding-quality parameter may seek to optimize size reduction within the predefined range of similarity (or difference).

For example, according to some embodiments, the quality parameter controller 30 may include a similarity evaluation module 32. The similarity evaluation module 32 may be adapted to implement in cooperation with the H.264 encoder 40 an iterative search for an encoding-quality parameter.

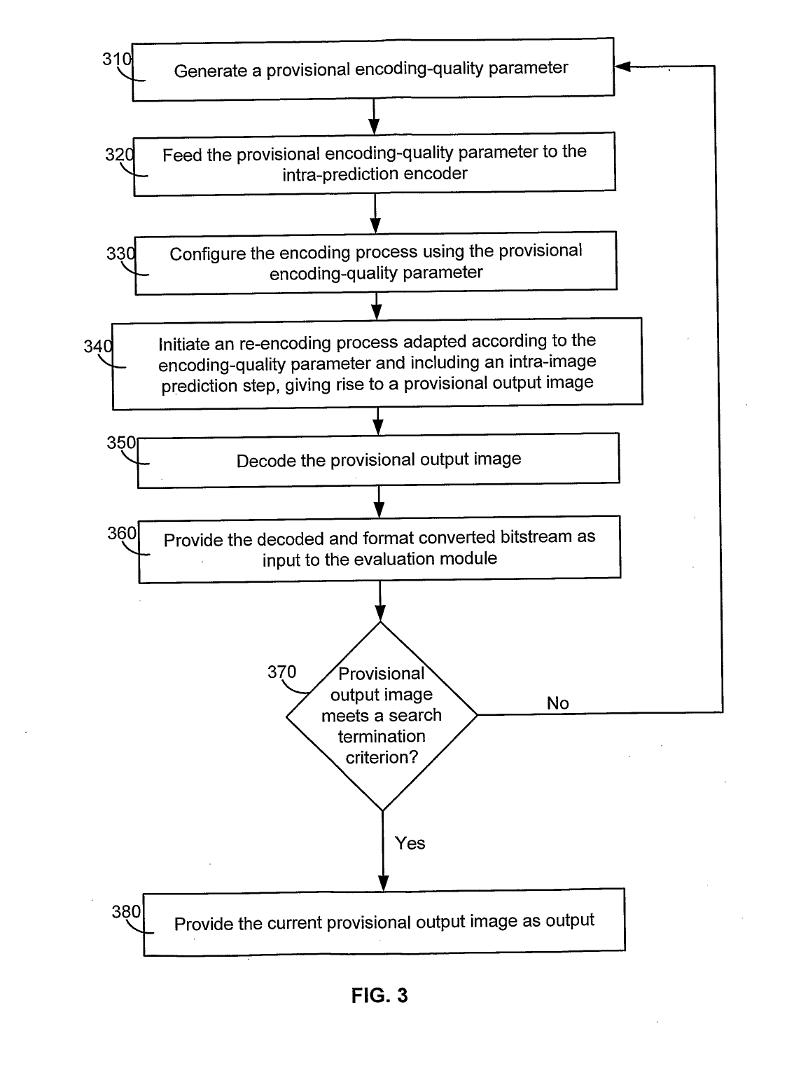

Reference is now made to FIG. 3, which is a flowchart illustration of an example of an iterative encoding-quality parameter search process which may be implemented as part of some embodiments of the present invention. At each iteration of the search process, the similarity evaluation module 32 may generate a provisional encoding-quality parameter (block 310) which is provided as input to the H.264 encoder 40 (block 320).

According to some embodiments, the initial provisional encoding-quality parameter may be predefined. For example, the initial provisional encoding-quality parameter may be preset to a value which corresponds to a H.264 quantization parameter value of 22. In further embodiments, the initial provisional encoding-quality parameter may be selected by an operator of the system 10. For example, the operator of the system 10 may be presented with two or more choices, each choice representing a different tradeoff between similarity and compression, and correspondingly, each choice associated with a different H.264 quantization parameter value. In further embodiments, the user choices cover a range which corresponds to H.264 quantization parameter values between 14 and 32. In yet further embodiments, the initial provisional encoding-quality parameter may be calculated or otherwise determined. For example, the initial provisional encoding-quality parameter may be determined based on parameters related to quality/resolution of the input image, external user-selected parameters, etc. Further by way of example, the possible choices for an initial provisional encoding-quality parameter may be constrained by a predetermined range, for example, only values which correspond to H.264 quantization parameter values between 14 and 32 can be considered.

In some embodiments, the provisional encoding-quality parameter may be updated by performing a bi-section on a limited range of encoding-quality parameters. In further embodiments, the encoding-quality parameter range is updated by performing a bi-section on values of encoding-quality parameters which are specified in a look-up table.

In some embodiments, the provisional encoding-quality parameter may be updated using an adaptive step size which depends on the iteration number and the distance from the target similarity measure. One such update scheme could be for example:

QPnew=QPold+sign(Δsimilarity)*min(step_{numIter},C₁*|ΔSimilarity|); (Formula f1)

Where: QPnew, QPold are the values of the encoding-quality parameter for the next iteration and last iteration respectively, Δsimilarity is as in Formula f2, step_{numIter} is a step size taken from a look-up-table and decreases as a function of the iteration count and C₁ is some constant, possibly 200, and

where: Δsimilarity=currSimilarity−ThresholdSimilarity (Formula f2)

Where: currSimilarity is the similarity evaluated with the image created in the last iteration, ThresholdSimilarity is the target similarity measure and Δsimilarity is the difference between them.

The H.264 encoder 40 may be responsive to receiving the provisional encoding-quality parameter for configuring the encoding process using the provisional encoding-quality parameter (block 330) and initiating a re-encoding process adapted according to the encoding-quality parameter for encoding the decoded representation of the input image (as generated by the JPEG decoder 22), the re-encoding process including an intra-image prediction step, giving rise to a provisional output image (block 340).

In some embodiments, the H.264 encoder 40, as an example, may include integrated decoder 45, and thus the encoder may be adapted to decode the provisional output image (block 350). In some embodiments, the decoded H.264 bitstream which corresponds to the provisional output image may undergo format conversation by a from-YCbCr format-conversion module 60 from YCbCr representation of the output image to RAW. The format conversion module 60 may be operatively connected to the evaluation module 32 and may feed the decoded and format converted bitstream as input to the evaluation module 32 (block 360).

The evaluation module 32 may evaluate the results of the current iteration of the search process to determine whether the provisional output image generated by the H.264 encoder 40 meets a search termination criterion (block 370). According to some embodiments of the invention, the termination criterion may relate at least to a similarity between the provisional output image and the input image. For example, as part of implementing the search termination criterion, the evaluation module 32 may calculate a quantitative measure of the similarity between the current provisional output image and the input image. By way of example, the evaluation module 32 may calculate a SSIM value representing the similarity between the current provisional output image and the input image. Further by way of example, the evaluation module 32 may calculate the SSIM value with the following parameters: an 11×11 Gaussian filter with sigma=1.5, and default values for the SSIM constants—[0.01, 0.03].

Further by way of example, the evaluation module 32 may penalize the SSIM quality measure, for example by squaring the obtained value, in smooth areas. Still further by way of example, smooth areas may be identified by calculating the local image variance in the original image and classifying areas for which the variance is below a threshold as smooth. Still further by way of example, the evaluation module 32 may set the variance threshold for images with a dynamic range of [0,255] to 10.

Further by way of example, the evaluation module 32 may calculate a modified SSIM quality measure, in which instead of averaging over all local SSIM scores, averaging is done over the areas with lowest SSIM, for example by discarding the 5% lowest outliers, and averaging over the next 10% lowest scores. In further embodiments, the evaluation module 32 may divide the image into blocks, possibly based on the input image resolution and the evaluation module 32 may calculate the SSIM score for each block separately, and then calculate a global quality score as the minimum block SSIM value, the RMS (Root Mean Square) of the block SSIM values or the average between the lowest block SSIM value and the mean of the block SSIM values. By way of example, a 32×32 block division is implemented for images less than 0.25 megapixels, a 64×64 block division is implemented for images between 0.25 megapixels and 1 megapixel, and a 128×128 block division is implemented for images larger than 1 megapixels.

Further by way of example, the evaluation module 32 may adapt the SSIM quality measure calculation by performing it on a selected portion of the pixels of the first image and the corresponding pixels of second image, instead of performing it on the whole image. Further by way of example, the evaluation module 32 may combine the differences between corresponding selected pixels into a single difference value by calculating their average. Further by way of example, the evaluation module 32 may combine the differences between corresponding selected pixels to a single difference value by calculating their RMS (root mean square). Further by way of example, the evaluation module 32 may distribute the location of the selected pixels evenly across the image area. Further by way of example, the evaluation module 32 may select the location of selected pixels randomly. Further by way of example, the evaluation module 32 may divide the image into substantially equal rectangular areas, and select a relative portion of pixels for measurement randomly from each rectangular area.

A detailed description of the structural similarity (SSIM) index method is provided in publication [6], and a comparative analysis of the reliability of SSIM for measuring similarity between images is provided in publication [7]. Publication [6] is hereby incorporated in its entirety.

In some embodiments, the search termination criterion may include an optimization criterion. In further embodiments, according to the optimization criterion, the evaluation module 32 may be configured to terminate the encoding-quality parameter search when a provisional output image optimizes a similarity (or difference) between the output image and the input image and a size reduction of the discrete output image.

In further embodiments, by way of example, the optimization criterion may take into account a convergence criterion according to which an optimal output image is also related to the difference in the size of the output image at a current iteration of the search compared to the size of the output image at one or more previous iterations. Further by way of example, a convergence criterion implemented by the evaluation module 32 is related to the rate of improvement in terms of a size reduction associated with the current provisional encoding-quality parameter compared to the size of reduction associated with one or more of the previous provisional encoding-quality parameters. In still further embodiments, the search for an encoding-quality parameter may be constrained by a minimum similarity threshold between the output image and the input image (or by a maximum difference threshold).

According to some embodiments, in case it is determined that the current provisional output image meets the search termination criterion, the similarity evaluation module 32 may indicate to the H.264 encoder 40 to provide the H.264 bitstream corresponding to the current provisional output image as the output of the re-encoding process (block 380).

In the above description, the proposed search for an encoding-quality parameter is implemented with respect to each one of multiple re-encoded provisional output images. There is now provided an alternative implementation of a search process for an encoding-quality parameter, which is based on segmentation of the image and implementing an encoding-quality parameter on a segment (and possibly on each segment) of the image, according to some embodiments of the invention.

In some embodiments, in case it is determined that the current provisional output image does not meet the search termination criterion, the similarity evaluation module 32 may be adapted to repeat the recompression of the input image using an adjusted provisional encoding-quality parameter (blocks 310-370) followed by an evaluation of the similarity between a resulting provisional compressed output image and the input image. The process of adjusting the provisional encoding-quality parameter and evaluating the recompression of the input image using the adjusted provisional parameter may be repeated until the similarity between the provisional compressed output image and the input image meets the similarity criteria.

In some embodiments, the encoding-quality parameter evaluation process, including the search for the encoding quality parameter, may be integrated with the encoding process. As part of the encoder integrated quality evaluation process, the encoding-quality may be evaluated on a portion of the image which has been coded, and distance from a target quantitative-similarity measure may be used in order to adapt the local encoding quality parameter for the evaluated portion of the image. According to further embodiments, as part of the encoding process, each image may be segmented and the encoding quality may be evaluated for each segment, and in case the encoded segment does not meet a target, e.g., a target quantitative-similarity measure, a further iteration of the encoding process may be initiated with respect to the respective segment with an updated encoding-quality parameter. Further by way of example, a further iteration of the encoding process may be initiated for an encoded segment for which the encoding quality is significantly above a target threshold, and therefore it may be possible to further compress the respective segment without crossing the target threshold. Further by way of example, the image may be segmented into rectangular blocks of substantially equal size, the size of the blocks may depend on the resolution of the input image. Further by way of example, the image may be segmented into regions of interest (based for example on textures or edges in the input image), in which case only a subset of blocks in each region are evaluated for the encoding-quality parameter, and the encoding-quality parameters for the rest of the blocks in the region are set to the same value as the encoding-quality parameter in the subset of blocks.

In further embodiments, the encoding quality evaluation module may be adapted to initiate an additional pass of the intra-prediction encoder over the image to encode the entire image using a constant (for the entire image) encoding-quality parameter that is found during the segment-wise search process. The constant encoding-quality parameter that may be used for encoding the entire image may correspond to one or more from the following, non-limiting and non-exhaustive, list: the average encoding-quality parameter, or the last value the search algorithm converged to.

The encoding quality parameter initialization and adaptation is performed essentially in the same manner as described above, or in the manner described below with general reference to an iterative encoding-quality search process. It would be appreciated however, that according to some embodiments, the segment search may be performed more frequently, at pre-determined evaluation points in the image encoding, such as after every macroblock or after N macroblocks, where N may be a fixed value or else set in accordance, for example, with image width or image overall size, and may change, for example, according to the convergence rate of the QP adaptation algorithm (also referred to herein as the iterative encoding-quality parameter search process). It would also be appreciated that in some embodiments, the quality parameter controller may be fully integrated with the intra-prediction encoder, and the encoding-quality evaluation process may be implemented directly as a part of the image encoding process.

Having described in length various implementations and embodiments of the invention which relate to an iterative encoding-quality parameter search process, there is now provided a description of additional embodiments and implementation of the present invention which may be used to determine or to facilitate determination of an encoding-quality parameter that is to be used for encoding an output image. These additional embodiments and implementations may be used in addition or as an alternative to the encoding-quality parameter search process.

According to further embodiments, the quality parameter controller 30 may include one or more look-up-tables (LUTs) which may provide an encoding-quality parameter (or a provisional encoding quality parameter) according to a parameter associated with some characteristic of the input image. By way of example, the LUTs may provide various H.264 quantization parameter factors (which in this example are the encoding-quality parameters) according to one or more of the following: bits-per-pixel, resolution and JPEG quality factor. For example, in table t1 below, for a given JPEG quality factor a corresponding H.264 quantization parameter is provided:

TABLE t1

| | Input JPEG Quality Factor | | | | | | | | | |
|---|---|---|---|---|---|---|---|---|---|---|
| | [0, 87) | [87, 89) | [89, 90) | [90, 92) | [92, 93.5) | [93.5, 95) | [95, 96.5) | [96.5, 98) | [98, 99.5) | [99.5 100) |
| Recommended | 27 | 26 | 25 | 24 | 23 | 22 | 21 | 20 | 19 | 18 |
| QP | | | | | | | | | | |

As mentioned above, any of the above proposed implementations of look-up-tables may be used, in some embodiments, as part of the search process for selecting an encoding-quality parameter, for example, to determine the initial provisional encoding-quality parameter. In further embodiments, in addition or as an alternative to the above implementations, the proposed look-up-table may be used to determine or to refine a range of encoding-quality parameters which should be considered for a given image, and from within the encoding-quality parameters range, a specific one encoding-quality parameter may be selected using, for example, the iterative search. Below there is included by way of example a LUT—table t2, which is an example of a LUT which provides an encoding-quality parameter range and a recommended QP according to a bits-per-pixel parameter of the input image:

TABLE t2

| | | | | | | Above |
|---|---|---|---|---|---|---|
| Input JPEG BPP | | [0,1) | [1, 2) | [2, 4) | [4, 6) | 6 |
| Recommended QP | | 25 | 23 | 20 | 19 | 17 |
| QP | minimum | 18 | 15 | 15 | 10 | 10 |
| RANGE | maximum | 32 | 32 | 31 | 27 | 25 |

In further embodiments, the quality parameter controller 30 may be configured to implement one or more formulae for calculating an encoding-quality parameter (or a provisional encoding quality parameter) using the formulae. According to some embodiments, the formula may provide an encoding-quality parameter according to a parameter associated with some characteristic of the input image. By way of example, the formula may return various H.264 quantization parameter factors according to one or more of the following: bits-per-pixel, resolution and JPEG quality factor. For example, in formula f3 below, for a given JPEG quality factor a corresponding H.264 quantization parameter is provided:

for QF<87 QP=27; for QF>=87 QP=round(−0.681QF+86.45); Formula f3

where QF is the JPEG quality factor and QP is a H.264 quantization parameter.

It would be appreciated that f3 is provided here as one example. Furthermore, as was mentioned above, the formula may be used as part of the search process for selecting an encoding-quality parameter, for example, to determine the initial provisional encoding-quality parameter. In further embodiments, in addition or as an alternative to the above implementations, a formula may be used to determine or to refine a range of encoding-quality parameters which should be considered for a given image, and from within the encoding-quality parameters range, a specific one encoding-quality parameter may be selected using, for example, the iterative search.

In yet further embodiments, the quality parameter controller 30 may be preprogrammed with a fixed encoding-quality parameter. The fixed encoding-quality parameter may be suitable for achieving a substantial size reduction of the output image compared to the input image while achieving a similarity which exceeds a minimal threshold quantitative-similarity. The preprogrammed fixed encoding-quality parameter may be selected according to predefined input image model or profile and in accordance with predefined parameters related to the desired size reduction. The input image model or profile may include values for one or more of the following parameters: a quantitative quality measure of the input image, a resolution of the input image, a compression level of the input image, a quality level indication of the input image (e.g., a JPEG quality value), a minimum non-zero DCT value of the input image, bits-per-pixel in the input image, a size of the input image etc. According to some embodiments, the fixed encoding-quality parameter may correspond to a quantization parameter within the range of approximately 15-25. In still further embodiments, the fixed encoding-quality parameter may correspond to a quantization parameter within the range of approximately 14-32. The quantization and the use of the quantization parameter shall be discussed in further detail below.

In further embodiments, a preliminary process may be implemented for identifying input images that are already highly compressed, and refrain from re-compressing them. It would be appreciated that attempting to recompress highly compressed input images may result in a very small reduction in output image file size, and/or in low perceptual quality of the output image. In some embodiments, the input image may be analyzed to identify whether it is highly compressed, and in case it is highly compressed, the encoding process may be disabled for the respective image. In further embodiments, identifying whether the input image is highly compressed is performed by analyzing the DCT coefficient values of the input image after dequantization, and determining the minimum non-zero DCT coefficient. In yet further embodiments, the minimum non-zero DCT coefficient is compared to a threshold. In some embodiment, the threshold is determined by evaluating all (or some) recompressed images for which the recompression rate is low (for example, below 10%) and examining the statistics of their non-zero DCT values. For example, a threshold of 3 for Luma may be used as described below. In some embodiments, such analysis is performed separately on the Luma and Chroma components of the image. In further embodiments, if the minimum non-zero DCT coefficient is higher than a threshold, the encoding process is not performed for the respective image. In yet further embodiments, the threshold is different for the Luma component and the Chroma components, and the final decision depends on a combination of the Luma and Chroma component thresholds. As mentioned above, here too, the threshold may be determined empirically by evaluating the statistics of DCT values in images whose recompression ratio is very low. In some embodiments, the threshold for the Luma component minimal non-zero DCT component is 3. In further embodiments, if the minimum non-zero DCT coefficient is above a threshold, the encoding process is not performed for the respective image. In yet further embodiments, the threshold is different for the Luma component and the Chroma components, and the final decision depends on a combination of the Luma and Chroma component thresholds.

Continuing with the description of FIGS. 1 and 2, according to some embodiments, the interface 20 may optionally include a resolution control module 24. Upon receipt of the discrete input image (a JPEG image in the case of FIG. 1), the resolution control module 24 may be adapted to obtain a parameter related to the resolution of the input image (block 215). For example, the resolution control module 24 may be adapted to extract the resolution of the input image from a certain metadata filed and included as part of or associated with the discrete input image. In the case of a JPEG input image 12 (and in the case of some other supporting formats), the resolution information is usually available from the exchangeable image file format (Exif) metadata that is embedded within the JPEG input image. The resolution of the input image may be denoted by a first number of pixels over a second number of pixels. In further embodiments, the interface 20 may be adapted to obtain additional metadata information related to the input image, including, for example, but not limited to: bits per pixel, image quality indication (e.g. JPEG quality value), file size, etc.

According to some embodiments, the resolution control module 24 may be adapted to provide the input image resolution parameter to the H.264 encoder 40. The H.264 encoder 40 may be adapted to control the resolution of the output image based at least in part on the input image resolution parameter (block 235). In some embodiments, the H.264 encoder 40 may be adapted to provide as output an image having a resolution which is substantially equal to the resolution of the input image.

In some embodiments, the H.264 encoder 40 may be adapted to pad the output image (compared to the row and column resolution of the input image) with one or with a substantially small number of pixel rows and/or columns; and/or the H.264 encoder 40 may be adapted to subtract from the output image (compared to the row and column resolution of the input image) one or a substantially small number of pixel rows and/or columns (this operation is sometimes referred to as image “cropping”). In further embodiments, the intra-prediction encoder 40 may determine whether padding (or cropping) of the output image is required and the number of padding rows and/or columns (or rows and/or columns to be subtracted) according to the input image resolution parameter.

It would be appreciated by those versed in the art that according to the H.264 standard, the number of pixel rows and columns is required to be an even number (although the pixel count is not necessarily equal among the rows and columns). According to some embodiments, in case of an input image having an uneven number of pixel rows and/or an uneven number of pixel columns, the intra-prediction encoder 40 may add or remove pixel rows and/or pixel columns, so that the number of pixel rows and columns in the output image is even.

In further embodiments, the intra-prediction encoder 40 may be otherwise configured to determine the resolution of the output image and may set the resolution of the output image to a number which is significantly different from the resolution of the input image. The resolution of the output image may be related, at least in part, to the resolution of the input image, but may substantially differ from the resolution of the input image. In still further embodiments, the intra-prediction encoder 40 may be configured to set the resolution of the output image independently of the resolution of the input image. For example, the resolution of the output image may be manually set by a user, or may be automatically configured according to requirements of a storage system or according to requirements of a software application with which the system 10 is associated.

In some embodiments, the H.264 encoder 40 may be adapted to split the output image into a plurality (two or more) of sub-images, wherein the resolution of each one of the sub-images is smaller or equal to the maximum resolution supported by the H.264 standard. In still further embodiments, the H.264 encoder 40 may create the sub-images by splitting the output image into rectangular regions. The order of the regions associated with each of the sub-images may be denoted by a predefined order of the sub-image, or it may be specified within or in associated with the sub-images. For example, a meta-tag may be embedded by the encoder in each of the sub-images indicating the respective sub-image's coordinate or column-row location. In still further embodiments, the sub-images may be stored as separate frames in a single H.264 stream, as separate H.264 tracks in a single MP4 file, or as separate H.264 files. The sub-images may be reconstructed by the decoder to recreate the original output image. In some embodiments, combining the plurality of sub-images may involve ordering the sub-images according to ordering information embedded within or associated with each of the sub-images or according to a predefined ordering scheme.

In still further embodiments, the sub-images may created by downsampling the output image, for example dividing into N images by selecting every Nth pixel in the output image. The downsampled sub-images may be stored as separate frames in a single H.264 stream, as separate H.264 tracks in a single MP4 file, or as separate H.264 files. The location of pixels in the downsampled in the original output image may be determined according to a predefined downsampling scheme, or it may be specified within or in associated with the sub-images. For example, a meta-tag may be embedded by the encoder in each of the sub-images indicating the respective sub-image's pixel-wise offset relative to the edges of the original output image. In order to reconstruct the original output image, the decoder reads the pixels of the downsampled images, and writes them to a reconstructed output image—having the same size as the original output image—at the location from where they (the pixels) were located in the original output image.

It would be appreciated by those versed in the art that the maximum resolution of images supported by the H.264 format is limited, for example to 9.4 Megapixels. According to some embodiments, in case of an input image having a resolution greater than the maximal resolution supported by the H.264 format, the intra-prediction encoder 40 may split the output image into two or more sub-images whose resolution is equal to or less than the maximal resolution supported by the H.264 format.

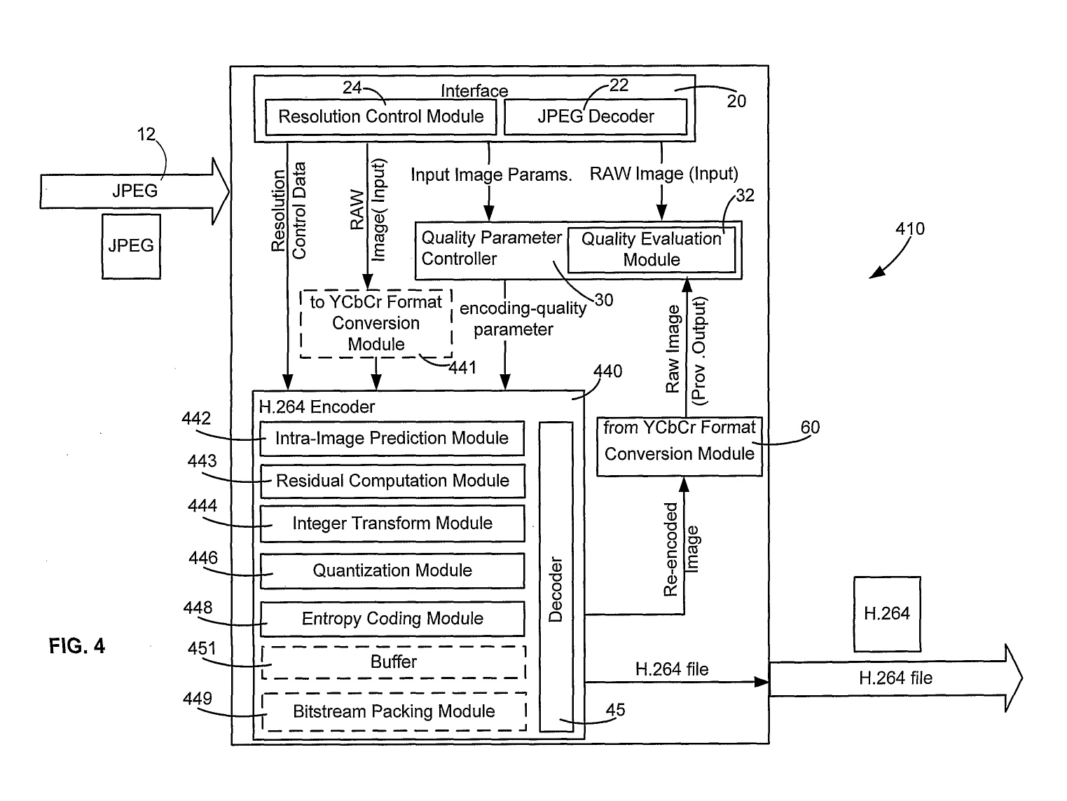

Reference is now made to FIG. 4, which is a block diagram illustration showing the system of FIG. 1 in further detail, according to some embodiments of the invention. As mentioned above, in some embodiments of the invention, the intra-prediction encoder may be a H.264 (or an MPEG-4 part 10) encoder 440. According to some embodiments, H.264 encoder 440 may be responsive to receiving from the quality parameter controller 30 an encoding-quality parameter (including a provisional encoding quality parameter) for initiating a re-encoding of the input image (or a representation of the input image) received at the system 400 and for providing a re-encoded, recompressed output image.

As mentioned above, the re-encoding process implemented by the H.264 encoder 440 is adapted according to the encoding-quality parameter provided by the quality parameter controller 30. As was also mentioned above, the re-encoding process implemented by the H.264 encoder 440 includes an intra-image prediction step. An example of one possible implementation of a re-encoding process which may be implemented by the H.264 encoder 440 is now provided.

In addition to the encoding-quality parameter received from the quality parameter controller 30, the H.264 encoder 440 may receive an input image (or a presentation thereof) that is to be re-encoded. For example, the H.264 encoder 440 may receive input image from the JPEG decoder 22 as a RAW format representation of the input image.

In some embodiments, the JPEG decoder 22 may decode the input JPEG image into a RAW format representation of the input image. The image processing system 410 may include a to-YCbCr format-conversion module 441 which may be adapted to convert the RAW format representation provided by the JPEG decoder 22 to a YCbCr format representation. According to yet further embodiments, the to-YCbCr format-conversion module 441 may also be adapted to modify the spatial resolution of the Cb and Cr components. By way of example, the to-YCbCr format-conversion module 441 may implement a 4:2:0 chroma sampling scheme to reduce the spatial resolution of the Cb and Cr components by a factor of 2 in the horizontal and vertical directions. It would be appreciated that other chroma sampling schemes may be used as part of further embodiments of the invention. It would be appreciated, that format conversion of JEPG bitstream into YCbCr is an integral process of standard JPEG decoding, and thus the to-YCbCr format-conversion module is optional and the YCbCr representation may be obtained directly from the JPEG decoder.

The H.264 encoder 440 may be configured to enable the H.264 intra-prediction feature and to disable the inter-prediction feature. The H.264 encoder 440 may provide the downsampled YCbCr values as input to an intra-image prediction module 442. According to some embodiments, the intra-image prediction module 442 may be adapted to partition the transformed representation of the input image into a plurality of macroblocks. In the case of H.264, macroblock partitioning is set forth by the standard. According to the H.264 standard, the transformed representation of the input image is partitioned to 16×16 macroblocks.

However, in further embodiments of the invention, the macroblock partition method implemented by the intra-prediction encoder may depart from or may be different from the standard H.264 partitioning method. For example, the intra-image encoder may be adapted to partition the JPEG image into 8×8 blocks, with intra-prediction which uses concepts similar to that of the H.264 standard intra-prediction but adapted to 8×8 blocks. By way of example, this configuration may be achieved by a propriety encoder (which is not compatible with the H.264 standard).

Continuing with the description of FIG. 4, the intra-image prediction module 442 may be adapted to predict one or more 16×16 macroblocks within the transformed representation of the input image from neighboring samples of macroblocks which surround the current macroblock. According to the H.264 standard 16×16 macroblock can be predicted from neighboring samples of previously-coded macroblocks which are to the left and/or above the block to be predicted. Further according to the H.264 standard, prediction may be carried-out on the entire block, or prediction may be performed separately from each 4×4 sub-block.

It would be appreciated that it is possible to devise and implement an intra-prediction encoder which implements and uses other block-size partitions schemes and which predicts blocks or sub-blocks according to a different pattern (e.g., it is not limited to predict from macroblocks/blocks which are to the left or above the current macroblock/block).

According to some embodiments, based on the intra-block prediction, an intra-predicted image may be determined, and a residual computation module 443, which is implemented as part of the H.264 encoder 440 is adapted to compute a residual image based on the intra-predicted image and the input image (or the representation of the input image received at the encoder).

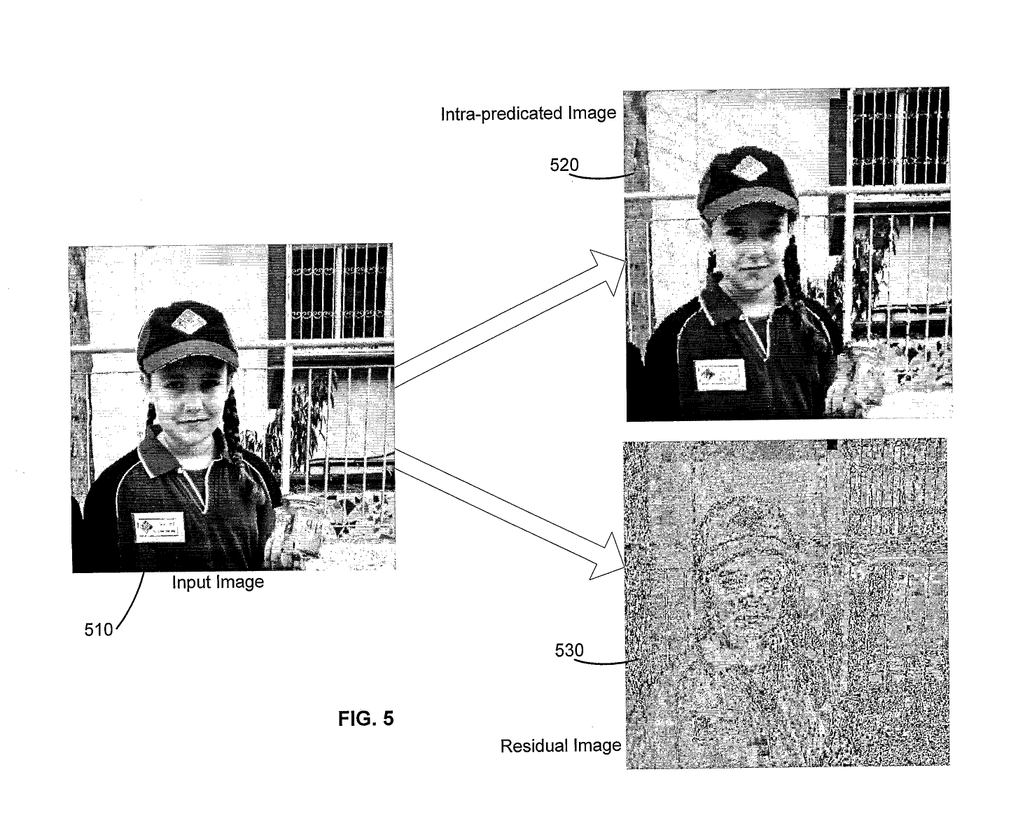

Reference is now made to FIG. 5, which shows a series of images depicting certain aspects of the H.264 standard intra-image prediction and residual image computation process which are implemented as part of a process of re-encoding a discrete input image, according to some embodiments of the invention. In FIG. 5, there is shown as part of some embodiments of the invention, an original image 510, an intra-predicted image 520 and a residual image 530.

The original image 510 is the discrete JPEG input image which was provided as input to the system for being recompressed. The intra-predicted image 520 is a representation of the image data generated from the input image 510 by predicting macroblocks or sub-blocks from neighboring macroblocks (in this case in accordance with the H.264 standard intra-image prediction). By subtracting the intra-prediction image 520 from the original input image 510, the result, a “difference” or residual image 530 is generated. As can be appreciated, due to the high accuracy of the prediction, in particular with respect to high resolution images, the intra-prediction image 520 is highly similar to the original input image 510, and so the residual image 530 is relatively compact in size.

Continuing with the description of FIG. 4, following the prediction and residual image computation, an integer transform module 444 which is also implemented within the H.264 encoder 440 is utilized to convert each color component of each 4×4 block of pixels of the residual image into the frequency domain. According to some embodiments, in compliance with the H.264 standard, the integer transform module 444 may be adapted to implement an integer transformation. It would be appreciated that it is possible to devise and implement an intra-prediction encoder which implements and uses other transformation techniques.

The transformed residual image is then passed to a quantization module 446 which is also integrated as part of the H.264 encoder 440. According to some embodiments of the present invention, the quantization module 446 may be configured by the H.264 encoder 440 in accordance with the encoding-quality parameter provided by the quality parameter controller 30. According to some embodiments the H.264 encoder 440 may configure the quantization parameter index value that is used by the quantization module 446 according to the encoding quality parameter provided by the quality parameter controller 30. Accordingly, the quantization module 446 is adapted to quantize the residual data according to the encoding-quality parameter provided by the quality parameter controller 30.

The quantized frequency domain representation matrix may be fed to the entropy coding module 448. The entropy coding module 448 may be adapted to reorder the quantized transform coefficients. For example, a zigzag scan may be performed on the matrix of the quantized transform coefficients. Once reordered, the entropy coding module 448 may be adapted to perform the entropy coding. By way of example, the entropy coding module 448 may be configured to implement one of the entropy coding techniques prescribed by the H.264 standard: the context-adaptive variable length coding (“CAVLC”) or context-adaptive binary arithmetic coding (CABAC).

According to some embodiments, the coded bitstream representation of the output image generated by the H.264 encoder 440 may be used to provide a re-compressed discrete output image which is perceptually lossless in relation to the discrete input image.

According to some embodiments, the H.264 encoder 440 may include a buffer 451. The buffer 451 may include volatile or non-volatile storage and may be utilized for substantially temporarily storing coded H.264 bitstream. By way of example, the buffer 451 may be used to temporarily store within the H.264 encoder 440 the coded bitstream representation of a provisional output image generated as part of an iterative search for an encoding-quality parameter. In some embodiments, at each iteration of the encoding-quality parameter search process, the buffer 451 may be updated and the coded bitstream representing the current provisional output image may be stored therein. Possibly, at each iteration of the search process, the previous provisional output image may be overwritten with the coded bitstream representing the current provisional output image. In further embodiments, when an indication is received (for example from the quality evaluation module 32) that the search termination criteria is met, the H.264 encoder 440 may retrieve the coded bitstream representation of the current provisional output image (which resulted in the search termination criterion being met) from the buffer 451. The H.264 encoder 440 may then provide the retrieved coded bitstream representation as the discrete output image.

As mentioned above, according to some embodiments, the H.264 encoder 440 may provide as output the coded (following the entropy coding) bitstream representation of the output image. In further embodiments, the bitstream representation of the output image is stored as a representation of the output image with some reference to the source input image. The association between the input image and the bitstream representation of the output image may be maintained using various method and techniques. In one example, a substantially unique GUID string or hash value that is substantially uniquely associated with the input image or with an identifier of the input image, and the GUID string or hash value may be recorded in association with the bitstream representation of the output image.

According to some embodiments, when a request is received to retrieve the output image, for example, by referencing an identifier of the input image, the bitstream representation of the output image may undergo a packing and formatting process and a file with the discrete output image may be returned. In some embodiments, the file may be compatible with the H.264 standard. In further embodiments, the file may be compatible with the JPEG standard. The packaging of a H.264 coded bitstream into a H.264 compatible file, and the packaging of a H.264 coded bitstream into a JPEG compatible file shall be described in greater detail below.

According to further embodiments, the packing of the re-encoded image as a H.264 file or as any other file in any other format that is compatible with the H.264 standard may be an integral part of the re-encoding process, and the H.264 encoder 440 may provide as output a H.264 compatible file.

According to some embodiments, the H.264 encoder 440 may include a bitstream packing module 449. The bitstream packing module 449 is adapted to receive as input the coded bitstream provided by the entropy coding module 448. Bitstream packing module 449 may pack the coded bitstream into a H.264-compatible file. In some embodiments, the bitstream packing module 449 may be adapted to add certain metadata information and/or headers which relate to various parameters and/or properties of the re-encoded discrete output image. By way of example, the bitstream packing module 449 may be adapted to add information about the resolution of the output image, a file extension for the output image, etc. According to further embodiments, the bitstream packing module 449 may be adapted to add to the coded bitstream certain metadata which relates to attributes or metadata of the input image (this data may also relate to the output image). For example, the bitstream packing module 449 may be adapted to add metadata which relates to the original resolution of the input image (e.g., the resolution before padding, cropping), the bits-per-pixel value of the input image, quality factor of the input image, etc.

It would be appreciated that multiple file formats support and are compatible with the H.264 bitstream, including, but not limited to the following file formats and file extensions: MPEG-4 (.mp4), Audio/Video Interleaved (.avi), Windows Media Video (.wmv), Advanced Streaming Format (.asf), Apple QuickTime (.mov), Adobe Flash (.flv).

The packed H.264-compatible file may be provided as output of the image processing system 410. It would be appreciated that since in accordance with some embodiments of the present invention, the re-encoded and re-compressed output image is provided as a H.264-compatible file, it can be decoded by any H.264-compatible decoder. It would be further appreciated that popular software applications which are in wide use today have embedded therein a H.264-compatible decoder or H.264 support (e.g., via an appropriate a software or plug-in extension) and would therefore be capable of displaying the re-encoded and re-compressed output image without any modification or additional software. By way of example, software applications that have embedded therein a H.264-compatible decoder may include the following: Apple Quick-Time multimedia framework and Safari Web browser by Apple Inc. (Cupertino, Calif.), Internet Explorer Web browser and Media player multimedia framework by Microsoft Corporation (Redmond, Wash.), Adobe Media Player by Adobe Systems Inc. (San Jose, Calif.), WinAmp by America Online LLC (New-York City, N.Y.) and Firefox Web browser by Mozilla Corporation (Mountain View, Calif.).

The inventors of the present invention, have found that using the appropriate quantization parameter for configuring the H.264 re-encoding process, it is possible to generate an encoded H.264 bitstream that is based on a discrete JPEG input image, and based on the H.264 bitstream to provide a discrete output image (e.g., via a H.264-compatible file) which is perceptually lossless (or perceptually identical) relative to the discrete JPEG input image, and the discrete output image is further characterized by a substantially reduced footprint compared to the discrete JPEG input image.

There is now provided a partial list of benefits which may be achieved through using a system in accordance with some embodiments of the invention for re-compressing and re-encoding an input JPEG image. It would be appreciated that the following list is non-exhaustive and is not binding, and that further embodiments of the invention may achieve one or more of the following or none thereof, and possible other advantages not listed below may be achieved through implementation of certain embodiments of the invention.

Enabling users to upload their photos to online photo sharing sites faster.

Enabling users to download photos from the Web (e.g., from online photo sharing sites) faster.

Reducing the amount of bandwidth used by online resources (e.g., photo sharing sites).

Enabling users to attach more photos to their email messages (currently users typically limit attachments to only a few full-resolution photos, in some cases due to restrictions on maximum message size).

Reducing the size of emails sent between users, and consequently reducing the amount of email traffic at various nodes on the Internet.

Reducing the amount of time it takes to load Web pages.

Reducing the bandwidth used by websites.

Increasing the number of photos that can be stored on camera memory cards or on any other storage device, in particular a portable storage device.

Reducing the amount of time required to transfer photos from the camera to the user's PC.

Reducing the amount of time required to backup user photos.

Reducing the amount of time required to transfer user photos to online photo and album printing services.

According to some embodiments of the invention, the system 410 may further include a JPEG encoder (not shown). In further embodiments, the JPEG encoder may be operatively connected to the H.264 encoder 440, and the H.264 encoder 440 may be configured to feed the JPEG encoder with a RAW format bitstream representing the discrete output image. As mentioned above, the H.264 encoder 440 includes an integrated decoder 45, and thus the encoder 440 may be capable of providing a decoded RAW format bitstream as output.

According to some embodiments, the JPEG encoder may receive the raw format representation of the discrete output image. The JPEG encoder may be responsive to receiving the raw data corresponding to the discrete output image for implementing a JPEG encoding process, which is known per-se, thereby giving rise to a JPEG format representation of the encoded H.264 bitstream representing the discrete output image.

The inventors of the present invention, have found that using the appropriate quantization parameter for configuring the H.264 re-encoding process, it is possible to generate an encoded H.264 bitstream, which when encoded back to JPEG format provides a discrete JPEG output image which is perceptually lossless (or perceptually identical) relative to the discrete JPEG input image, and the discrete JPEG output image is further characterized by a substantially reduced footprint compared to the discrete JPEG input image.

In the embodiments shown in FIGS. 1-5 and in the description thereof provided herein reference is made to recompression of JPEG images. It would be appreciated, that FIGS. 1-5 and the description thereof herein, provide an example of one implementation of the proposed system. It would be further appreciated that further embodiments of the invention are not limited to recompression of JPEG images and that a system similar to the system shown in FIGS. 1-5 may be readily devised by those versed in the art for recompressing an input image that was encoded using a format other than JPEG, and in particular a compression format utilizing independent coding of disjoint blocks.

Furthermore, in some of the embodiments shown in FIGS. 1-5 and in the description thereof provided herein reference is made to recompression of discrete input images using a H.264 encoder. It would be appreciated, that FIGS. 1-5 and the description thereof provided herein provide an example of one implementation of the proposed system. It would be further appreciated that further embodiments of the invention are not limited to recompression of discrete input images using the H.264 format (or the MPEG-4 part 10 format) and that a system similar to the system shown in FIGS. 1-5 may be readily devised by those versed in the art for recompressing an input image using an intra-prediction encoder which is based on a format other than H.264, and in particular a compression format utilizing intra-image prediction and a controllable quantization processes.

According to a further aspect of the invention, a system for processing a discrete input image to a reduced-size discrete output image may include an interface, a quality parameter controller and an encoder, wherein the interface is adapted to receive a discrete input image compressed by a compression format utilizing wavelets transform. The quality controller is adapted to provide an encoding-quality parameter enabling a substantial size reduction of the discrete output image, wherein the parameter is related to a target quantitative-similarity measure between the output image and the input image. The encoder is adapted to re-encode the input image using intra-image prediction implemented in accordance with the encoding-quality parameter.

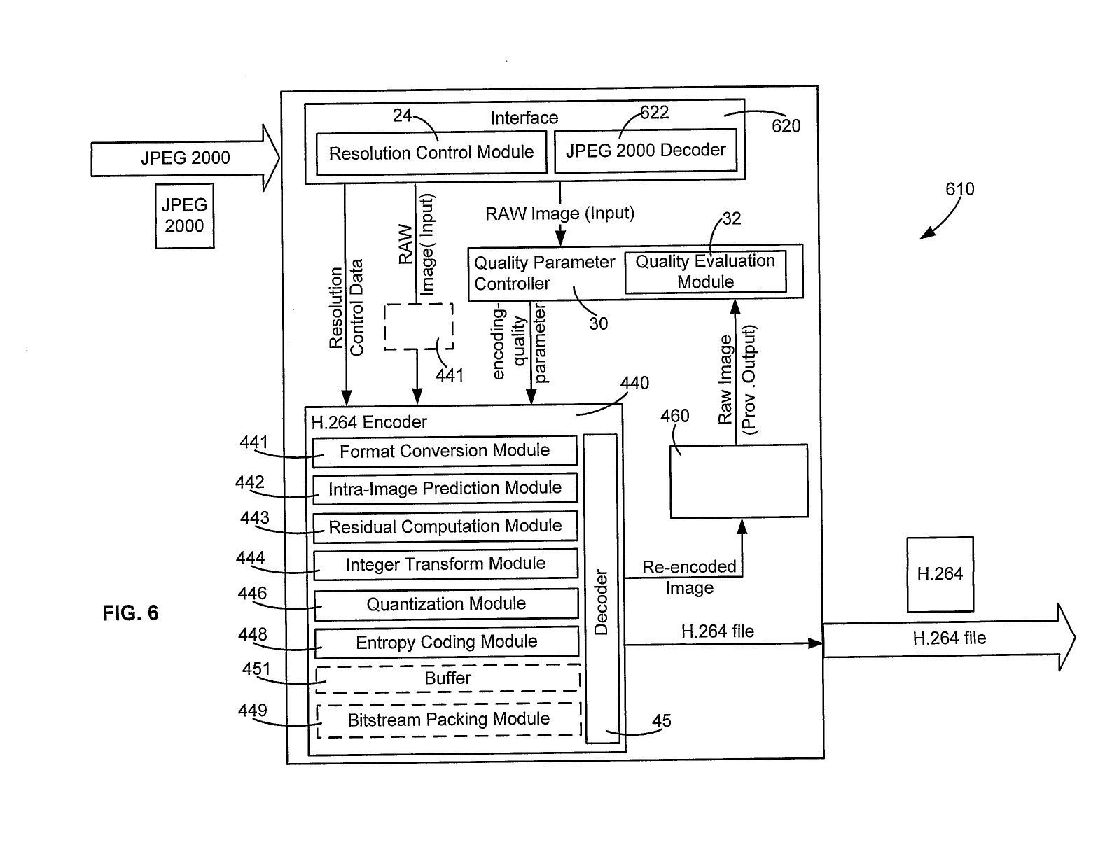

Reference is now made to FIG. 6, which is a block diagram illustration of an image processing system suitable for processing JPEG 2000 images, according to some embodiments of the invention. The system 610 shown in FIG. 6 shares some similar components as the system shown in FIG. 4. It would be appreciated that the re-encoding process implemented with respect to the JPEG input image, which was described above in detail with reference to FIG. 4, may be implemented in a similar manner with respect to a discrete input image that was encoded using a compression format utilizing wavelets transform, such as the JPEG 2000.

As is shown in FIG. 6, and according to some embodiments of the invention, a discrete JPEG 2000 input image may be received at the image processing system 610. The JPEG 2000 input image may be received through an interface 620 component of the processing system 610. The interface 620 may include a JPEG 2000 decoder 622 that is adapted to decode the discrete input image into a RAW image format or into a predefined lossless image format. Once converted to RAW format the image data can be fed to the quality parameter controller 30 and to the intra-prediction encoder 40 where it is handled in a manner that is similar to what was described above with reference to FIGS. 1-5. It would be appreciated by those versed in the art that when processing RAW image data, the original encoding format from which the RAW image data was generated is practically not significant.

According to some embodiments, the image processing system 610 shown in FIG. 6 may provide as output the coded (following the entropy coding) bitstream representation of the output image; a H.264 compatible file including the coded bitstream representation of the output image; and a JPEG 2000 image file which is encoded based on a RAW data representation of the H.264 of the output image (or based on the coded bitstream representation of the output image).

The inventors of the present invention have found that using the appropriate quantization parameter for configuring the H.264 re-encoding process, it is possible to generate an encoded H.264 bitstream that is based on a discrete JPEG 2000 input image, and based on the H.264 bitstream to provide a discrete output image (e.g., via a H.264-compatible file) which is perceptually lossless (or perceptually identical) relative to the discrete JPEG 2000 input image, and the discrete output image is further characterized by a substantially reduced footprint compared to the discrete JPEG 2000 input image.

The inventors of the present invention have found that using the appropriate quantization parameter for configuring the H.264 re-encoding process, it is possible to generate an encoded H.264 bitstream that is based on a discrete JPEG 2000 input image, and the H.264 bitstream when encoded back to JPEG 2000 format provides a discrete JPEG 2000 output image which is perceptually lossless (or perceptually identical) relative to the discrete JPEG 2000 input image, and the discrete JPEG 2000 output image is further characterized by a substantially reduced footprint compared to the discrete JPEG 2000 input image.

It would be appreciated that further embodiments of the invention are not limited to recompression of JPEG 2000 images and that a system similar to the system shown in FIG. 6 may be readily devised by those versed in the art for recompressing an input image that was encoded using a format other than JPEG 2000, and in particular a compression format utilizing wavelets transform.

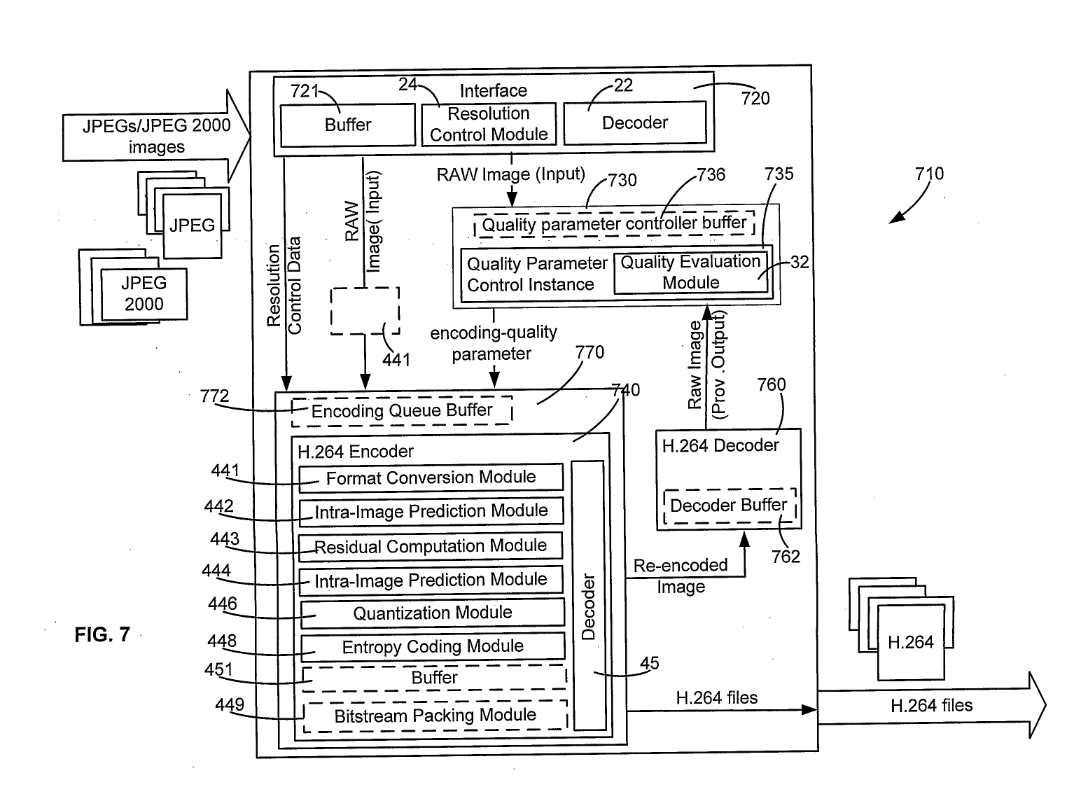

Having described certain aspects of the invention which relate to the processing of discrete input image and in which the output is a discrete output image, there is now provided a description of further aspects of the invention which relate to processing of multiple input images. Reference is now made to FIG. 7, which is a block diagram illustration of an image processing system suitable for processing multiple input images, according to some embodiments of the invention.

According to some embodiments, an image processing system 710 may be operatively connected to a mass storage system (not shown) on which a plurality of images is stored. According to some embodiments, a plurality of images from the mass storage system may be provided as input to the image processing system 710. According to some embodiments, the plurality of input images may be compressed images. The compression/encoding format used to compress/encode the input images may be a lossy compression format which does not include intra-prediction. For example, the input images may include images compressed using independent coding of disjoint blocks and/or image compressed using wavelets transform and/or images compressed using intra-prediction encoding. Further by way of example, the input images may include JPEG images and/or JPEG 2000 images and/or H.264 images.

The system 710 shown in FIG. 7, shares some similar components as the system shown in FIGS. 4 and 6. It would be appreciated that the re-encoding process implemented with respect to the discrete JPEG input image and the re-encoding process implemented with respect to the discrete JPEG 2000 input image, which was described above in detail with reference to FIGS. 4 and 6, may be implemented in a similar manner for batch processing a plurality of input images.

As is shown in FIG. 7, and according to some embodiments of the invention, a plurality of JPEG and/or JPEG 2000 input images may be received at the image processing system 710. According to some embodiments, the interface 720 of the system 710 for processing multiple input images may include a buffer 721 which may be used to balance the load within the system 710 in case any of the system's components is unable or is refusing to accept further images for processing.

In FIG. 7, and according to some embodiments of the invention, the quality parameter controller 735 may be implemented as a multithreaded management module which is adapted to invoke and control a plurality of quality parameter control instances 730. According to some embodiments, each quality parameter control instance 730 is functionally similar to the quality parameter controller 30 shown in FIGS. 1 and 4. According to some embodiments, the quality parameter controller 735 may include a quality parameter controller buffer 736 which may be used by the quality parameter controller 735 for internally controlling the load within the quality parameter controller 735.

In FIG. 7, and according to some embodiments of the invention, the system 710 may include an intra-prediction encoding controller 770. The intra-prediction encoding controller 770 may be implemented as a multithreaded management module which is adapted to invoke and control a plurality of instances of an intra-prediction encoder 740. According to some embodiments, each instance of the intra-prediction encoder 740 is functionally similar to the intra-prediction encoder 440 shown in FIG. 4 and described above. According to some embodiments, the intra-prediction encoding controller 770 may include an encoding queue buffer 772 which may be used by the intra-prediction encoding controller 770 for internally controlling the load on the encoder.

The from-YCbCr format-conversion module 760 may also be implemented as a multithreaded module or process each thread of the from-YCbCr format-conversion module 760 may be used to convert the decoded H.264 bitstream provided by the plurality of instances of an intra-prediction encoder 740 to RAW image data. The conversion module 760 may include a buffer 762 which may be used for internal load balancing.

In some embodiments, the interface 720 may be operatively connected to each of the quality parameter controller 735 and the intra-prediction encoding controller 770, and may monitor operational parameters the system's 710 components. In some embodiments, the interface 720 may monitor the load status within each of the quality parameter controller 735 and the intra-prediction encoding controller 770, and possibly also within the optional conversion module 760. In further embodiments, the interface 720 may control the interface buffer 721 according to the load status of one or more of the quality parameter controller 735 and the intra-prediction encoding controller 770, and possibly also to the optional conversion module 760.

According to some embodiments, the image processing system 710 shown in FIG. 7 may provide as output a plurality of output images and wherein each one of the plurality of output images corresponds to a respective input image from the plurality of input image received at the image processing system 710. According to some embodiments, one or more of the output images may be provided as a coded (following the entropy coding) H.264 bitstream representation. In further embodiments, one or more of the output images is a H.264 compatible file including the coded bitstream representation of the output image. In yet further embodiments, one or more of the input images is a JPEG or JPEG 2000 image file which is encoded based on a RAW data representation of the H.264 of the output image (or based on the coded bitstream representation of the output image).

In some embodiments of the invention, the plurality of re-encoded and re-compressed images may be returned to the mass storage system from whence they were received, and the plurality of re-encoded and re-compressed images may be stored as replacement of the original images that were used as the plurality of input images.

The inventors of the present invention have found that using the appropriate quantization parameter for configuring the H.264 re-encoding process, it is possible to generate encoded H.264 bitstreams that are based on respective JPEG or JPEG 2000 input images, and based on the H.264 bitstreams to provide a plurality of discrete output images (e.g., via a H.264-compatible file) which are perceptually lossless (or perceptually identical) relative to the respective JPEG or JPEG 2000 input image, and the plurality of output images are further characterized by a substantially reduced footprint compared to the plurality of JPEG or JPEG 2000 input images.

It would be appreciated by those versed in the art, that many of the functional components of the system 710 shown in FIG. 7 may be implemented as distributed components. For example, the quality parameter control instances 730 may be distributed and implemented on a plurality of computers. The quality parameter controller 735 may be implemented as a central control unit which controls the operation of each of the remote quality parameter control instances 730. The quality parameter controller 735 may provide an abstraction layer which is implemented over the remote quality parameter control instances 730 and may enable control and configuration of the plurality of remote quality parameter control instances 730 from a central location. In a similar manner, the interface 720 and it sub-components and the intra-prediction encoding controller 770 and its subcomponents may be distributed.

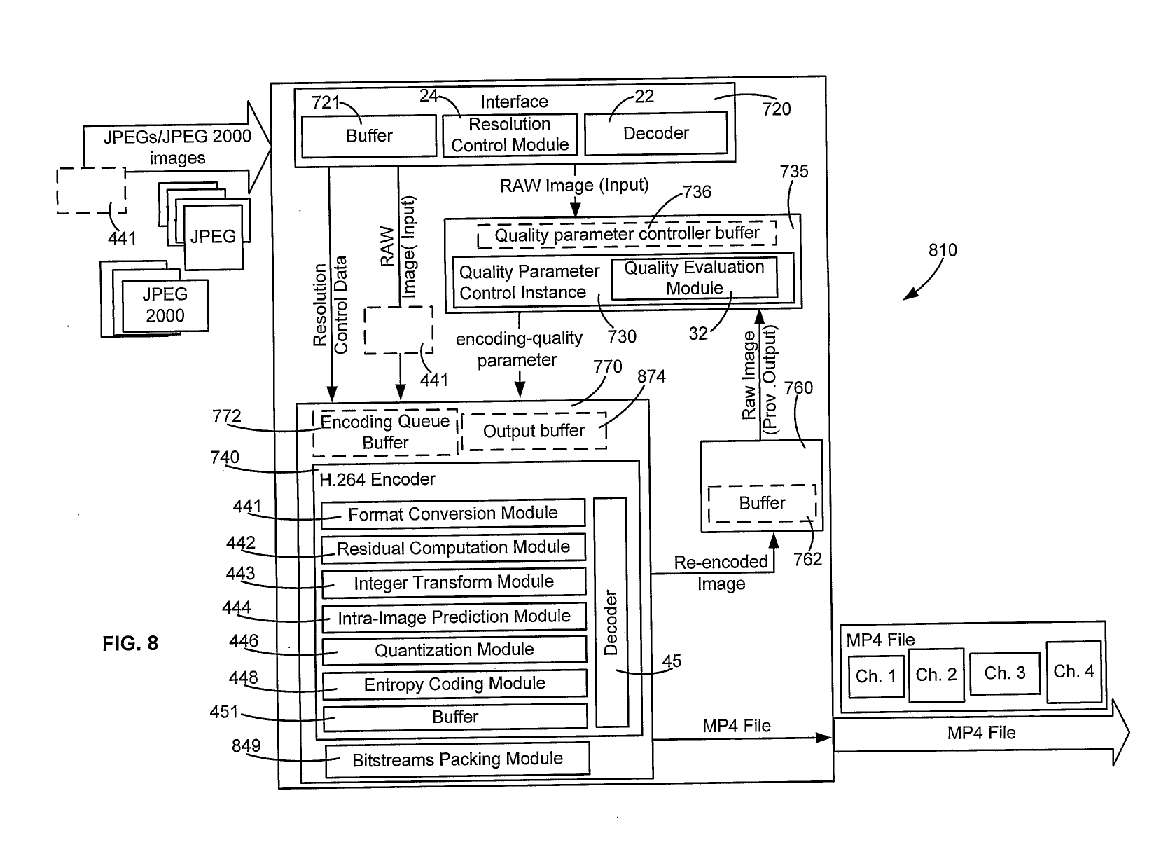

Having described a system for processing multiple input images to provide a corresponding plurality of re-compressed output images, there is now provided a description of a further aspect of the present invention, which relates to a system for processing a plurality of input images. Reference is now made to FIG. 8 which is a block diagram illustration of an image processing system suitable for processing multiple input images and for re-compressing multiple input images into a discrete output file including a plurality of discrete segments, according to some embodiments of the invention.

According to some embodiments the plurality of input images may be compressed images. The compression/encoding format used to compress/encode the input images may be a lossy compression format which does not include intra-prediction. For example, the input images may include images compressed using independent coding of disjoint blocks and/or image compressed using wavelets transform and/or images compressed using intra-prediction encoding. Further by way of example, the input images may include JPEG images and/or JPEG 2000 images and/or H.264 images.

The system 810 shown in FIG. 8 shares some similar components as the system 710 shown in FIG. 7. It would be appreciated that, in some embodiments, the re-encoding process implemented with respect to the plurality of JPEG or JPEG 2000 input image which was described above in with reference to FIG. 7, may be implemented in a similar manner by the system 810 shown in FIG. 8. However one or more components of the system 810 shown in FIG. 8 may be different from the system 710 shown in FIG. 7 and the output provided by the system 810 shown in FIG. 8 may be different from the output of the system 710 shown in FIG. 7.

According to some embodiments, the interface 720 may receive a plurality of input images, for example JPEG or JEPG 2000 input images. The quality parameter controller 735 may provide an encoding-quality parameter for each of the plurality of input images. In some embodiments, quality parameter controller 735 may provide a specific encoding-quality parameter for each of the plurality of input images, for example, based on a result of an iterative search for an encoding-quality parameter implemented for each of the plurality of input images. The iterative search was described above in greater detail.

For each one of the input images, a corresponding RAW representation of the input image may be fed to an intra-prediction encoder 740. The intra-prediction encoder 740 may also receive for one of the input images the respective encoding-quality parameter. The intra-prediction encoder 740 may be adapted to encode each one of the plurality of images. The intra-prediction encoder 740 may configure the encoding process of each one of the plurality of images according to the respective encoding-quality parameter. The encoding process of each one of the plurality of images may include intra-image prediction.

According to some embodiments, an intra-prediction encoding controller 770 may be used to control the operation of the intra-prediction encoder 740. The intra-prediction encoding controller 770 may be adapted to generate a single output file for the plurality of input images. In further embodiments, the encoding process of each one of the plurality of images may give rise to a respective coded bitstream and the intra-prediction encoding controller 770 may generate an object within the single output file for each one of the plurality of input images based on the input image's respective coded bitstream.

In some embodiments, the input images may be encoded simultaneously by a multithreaded encoder 740 and the single output file may be generated on-the-fly. Alternatively, according to further embodiments of the invention, one or more of the input images may be encoded in series, and whenever a coded bitstream is generated for one of the plurality of input images the coded bitstream or the output file object generated based on the coded bitstream is temporarily stored within an output buffer 874.

According to some embodiments, once a coded bitstream is generated for each one of the plurality of input images, a bitstreams packing module 849 may be adapted to generate a single file which includes a plurality of discrete objects and wherein each one of the plurality of discrete objects is associated with a respective one of the plurality of input images. More particularly, each one of the plurality of discrete objects is produced based on the coded bitstream generated for the respective input image. In some embodiments, each object within the single output file includes a discrete image which corresponds to a respective one of the plurality of input images.

According to some embodiments, the bitstreams packing module 849 may be adapted to index each one of the objects which corresponds to an output image. The media objects are indexed at the beginning of the file for enabling quick access to specific objects within the file. The index may be used for retrieving discrete images from the multi-object file. The bitstreams packing module 849 may include the index within the header of the output file and may thus enable rapid random access to each one of the objects included in the output file.

It would be appreciated by those versed in the art that advanced media file formats such as the MP4 file format, for example, enable inclusion of multiple different media objects within a single file. Each object within the single file may have unique media characteristics (size, resolution, codec, etc.) and may include metadata specifying its media characteristics. The characteristics of the object within the output file may be provided by the interface 720 and may correspond to characteristics of the respective input image. In addition or as an alternative, the characteristics of the objects within the output file may be provided by the quality parameter controller 735 and may correspond to the encoding quality parameter provided by the quality parameter controller 735. Further in addition or as an alternative, the characteristics of the object within the output file may be provided by the intra-prediction encoder 740 and may be associated with the encoding of the input image (or of the representation of the input image).

According to some embodiments, the image processing system 810 shown in FIG. 8 may provide as output a single output file including a plurality of (multimedia) objects, wherein each object includes an output image and wherein each output image corresponds to one of a plurality of input images. According to further embodiments, each object corresponds to a recompressed bitstream generated for the respective input image. In still further embodiments, the single output file is a MP4 multimedia file.

It would be appreciated by those versed in the art that clustering several images into a single file (for example, a whole user photo album), in accordance with some embodiments of the present invention, may be advantageous at least under certain circumstances. The following is a non-exhaustive list of some benefits of the single output file implementation described above:

Managing the images may become simpler and easier, since the number of managed files may be substantially reduced.

Access time to the individual images may be reduced, since once the file is retrieved and opened, subsequent images may be accessed without accessing the storage medium again.

The metadata for the plurality of image may be reduced. Allocating a separate file for an image creates a large metadata overhead for each image, which is inefficient and adversely effects various operations and systems involving processing of a plurality of images. For example, bottlenecks occur on the I/O operations of the metadata. Reading metadata once from a single file that contains multiple images may significantly reduce the I/O operations per image and may be more efficient.

It would be also appreciated however, that the image processing system 810 shown in FIG. 8 and described herein above, as well as the method of operating the system 810, which was also described above, may implement mutatis-mutandis over a single input image input. Accordingly, the image processing system 810 may be used for re-encoding and recompressing a single image and for packing the re-encoded image within a single output file including a multimedia object which corresponds to the input image. According to further embodiments, each object corresponds to a recompressed bitstream generated for the respective input image. In still further embodiments, the single output file is a MP4 multimedia file.

While certain features of the invention have been illustrated and described herein, many modifications, substitutions, changes, and equivalents will occur to those skilled in the art. It is therefore to be understood that the appended claims are intended to cover all such modifications and changes as fall within the true scope of the invention.

1. A system for processing a discrete input image to a reduced-size discrete output image, comprising:
an interface adapted to receive a discrete input image compressed by a compression format utilizing independent coding of disjoint blocks;
a quality parameter controller adapted to provide an encoding-quality parameter enabling a substantial size reduction of the discrete output image, wherein the parameter is related to a target quantitative-similarity measure between the output image and the input image; and
an intra-prediction encoder adapted to re-encode the input image, wherein re-encoding includes intra-image prediction, and wherein the encoder is configured in accordance with the encoding-quality parameter.

2. The system according to claim 1, wherein the discrete input image is a standard JPEG image.

3. The system according to claim 1, wherein the output image is provided in a standard H.264 format.

4. A system for processing a discrete input image to a reduced-size discrete output image, comprising:
an interface is adapted to receive a discrete input image compressed by a compression format utilizing wavelets with lossless or lossy quantization and block-by-block bit-plane entropy coding;
a quality parameter controller adapted to provide an encoding-quality parameter enabling a substantial size reduction of the discrete output image, wherein the parameter is related to a target quantitative-similarity measure between the output image and the input image; and
an intra-prediction encoder adapted to re-encode the input image, wherein re-encoding includes intra-image prediction, and wherein the encoder is configured in accordance with the encoding-quality parameter.

5. The system according to claim 4, wherein the discrete input image is a standard JPEG 2000 image.

6. The system according to claim 4, wherein the output image is provided in a standard H.264 format.

7. A method processing a discrete input image to a reduced-size discrete output image, comprising:
receiving a discrete input image compressed by a compression format utilizing independent coding of disjoint blocks;
providing an encoding-quality parameter enabling a substantial size reduction of the discrete output image, wherein the parameter is related to a target quantitative-similarity measure between the output image and the input image; and
re-encoding the input image, wherein re-encoding includes intra-image prediction, and a quantization step that is configured in accordance with the encoding-quality parameter.

8. A method processing a discrete input image to a reduced-size discrete output image, comprising:
receiving a discrete input image compressed by a compression format utilizing wavelets with lossless or lossy quantization and block-by-block bit-plane entropy coding;
providing an encoding-quality parameter enabling a substantial size reduction of the discrete output image, wherein the parameter is related to a target quantitative-similarity measure between the output image and the input image; and
re-encoding the input image, wherein re-encoding includes intra-image prediction, and a quantization step that is configured in accordance with the encoding-quality parameter.

9. A system for processing a plurality of input images to provide a respective plurality of reduced-size output images, comprising:
an interface adapted to receive a plurality of discrete input images compressed by a compression format utilizing independent coding of disjoint blocks or compressed by a compression format utilizing wavelets with lossless or lossy quantization and block-by-block bit-plane entropy coding;
a quality parameter controller adapted to provide for each one of the plurality of input images an encoding-quality parameter enabling a substantial size reduction of the respective discrete output image, wherein the parameter is related to a target quantitative-similarity measure between the respective output image and input image pair; and
an intra-prediction encoding controller adapted to re-encode each one of the plurality of input images, wherein re-encoding includes intra-image prediction, and wherein the encoder is configured in accordance with the respective encoding-quality parameter provided for each one of the plurality of input images.

10. The system according to claim 9, further comprising a plurality of quality parameters control instances under the control of said quality parameter controller, and wherein each one of the plurality of quality parameters control instances is assigned with one or more of the plurality of input images and is adapted to provide for each one of the input images assigned thereto an encoding-quality parameter enabling a substantial size reduction of the respective discrete output image, wherein the parameter is related to a target quantitative-similarity measure between the respective output image and input image pair.

11. The system according to claim 9, further comprising a plurality of instances of an intra-prediction encoder and wherein each one of the plurality of instances of the intra-prediction encoder is assigned with one or more of the plurality of input images to re-encode each one of the input images assigned thereto, wherein re-encoding includes intra-image prediction, and wherein the encoder is configured in accordance with the respective encoding-quality parameter provided for each one of the input images assigned to the encoder instance.

12. A system for processing a plurality of input images, comprising:
an interface adapted to receive a plurality of discrete input images compressed by a compression format utilizing independent coding of disjoint blocks or compressed by a compression format utilizing wavelets with lossless or lossy quantization and block-by-block bit-plane entropy coding;
a quality controller adapted to provide for each one of the plurality of input images an encoding-quality parameter enabling a substantial size reduction of the respective discrete output image, wherein the parameter is related to a target quantitative-similarity measure between the respective output image and input image pair;
an intra-prediction encoder adapted to re-encode each one of the plurality of input images, wherein re-encoding includes intra-image prediction, and wherein the encoder is configured in accordance with the respective encoding-quality parameter provided for each one of the plurality of input images; and
a bitstreams packing module adapted to provide a single output file for the plurality of input images, the output file including a plurality of indexed discrete objects corresponding to the plurality of discrete input images.

13. The system according to claim 12, wherein each one of the objects includes a discrete image which corresponds to a respective one of the plurality of discrete input images.

14. The system according to claim 12, wherein the output file is an MP4 file.

15. A method of processing a plurality of input images to provide a respective plurality of reduced-size output images, comprising:
receiving a plurality of discrete input images compressed by a compression format utilizing independent coding of disjoint blocks or compressed by a compression format utilizing wavelets with lossless or lossy quantization and block-by-block bit-plane entropy coding;
providing for each one of the plurality of input images an encoding-quality parameter enabling a substantial size reduction of the respective discrete output image, wherein the parameter is related to a target quantitative-similarity measure between the respective output image and input image pair; and
re-encoding each one of the plurality of input images, wherein re-encoding includes intra-image prediction, and wherein a quantization step is configured in accordance with the respective encoding-quality parameter provided for each one of the plurality of input images.

16. A method of processing a plurality of input images, comprising:
receiving a plurality of discrete input images compressed by a compression format utilizing independent coding of disjoint blocks or compressed by a compression format utilizing wavelets with lossless or lossy quantization and block-by-block bit-plane entropy coding;
providing for each one of the plurality of input images an encoding-quality parameter enabling a substantial size reduction of the respective discrete output image, wherein the parameter is related to a target quantitative-similarity measure between the respective output image and input image pair;
re-encoding each one of the plurality of input images, wherein re-encoding includes intra-image prediction, and wherein a quantization step is configured in accordance with the respective encoding-quality parameter provided for each one of the plurality of input images; and
providing a single output file for the plurality of input images, the output file including a plurality of indexed discrete objects corresponding to the plurality of discrete input images.

17. A system for processing a discrete input image to a reduced-size discrete output image, comprising:
an interface adapted to receive a discrete input image compressed by a compression format utilizing intra prediction encoding;
a quality parameter controller adapted to provide an encoding-quality parameter enabling a substantial size reduction of the discrete output image, wherein the parameter is related to a target quantitative-similarity measure between the output image and the input image; and
an intra-prediction encoder adapted to re-encode the input image, wherein re-encoding includes intra-image prediction, and wherein the encoder is configured in accordance with the encoding-quality parameter.

18. The system according to claim 17, wherein the discrete input image is provided in a standard H.264 format.

19. The system according to claim 17, wherein the output image is provided in a standard H.264 format.

20. The system according to claim 3, wherein the output image is split into two or more sub-images, wherein the resolution of each of said sub-images is smaller or equal to the maximum image resolution supported by the H.264 format.

21. The system according to claim 6, wherein the output image is split into two or more sub-images, wherein the resolution of each of said sub-images is smaller or equal to the maximum image resolution supported by the H.264 format.
